(19) United States
(12) Patent Application Publication
(10) Pub. No.: US 2024/0317606 A1
(43) Pub. Date: Sep. 26, 2024

(54) REFRIGERATOR WITH MODULAR CARTRIDGES IN FLUID COMMUNICATION WITH THE WATER SUPPLY

(71) Applicant: Midea Group Co., Ltd., Beijiao (CN)

(72) Inventor: Gregory Butorin, Louisville, KY (US)

(21) Appl. No.: 18/442,931

(22) Filed: Feb. 15, 2024

Related U.S. Application Data
(63) Continuation-in-part of application No. 18/471,015, filed on Sep. 20, 2023.
Application No. 18/471,015 is a continuation-in-part of application No. 18/188,087, filed on Mar. 22, 2023.

(51) Int. Cl. C02F 1/00; F25D 23/12

(52) U.S. Cl. CPC C02F 1/003; C02F 1/008; F25D 23/126; C02F 2201/005; C02F 2201/006; C02F 2209/40; C02F 2307/12; F25D 2323/121

(57) ABSTRACT

A refrigerator apparatus and method utilizing one or more water cartridges to customize the water supply. The water cartridge may include a coupler. The water cartridge may include a cartridge head assembly. A plurality of water cartridges may be combined in fluid/electrical communication with each other to customize the water supply. The water cartridge may include one or more electronic devices, or portions thereof. The water cartridge may include at least a portion of a flow sensor.

### BACKGROUND

Typical residential refrigerators generally include a water filter device provided with a water filter to purify water supplied from an external water supply source. However, the consumer has limited ability to customize/modify the filtering and/or the water supplied/used. In addition, some refrigerators include sensors (e.g. flow) such as flow meters to measure the volume of water dispensed, generally to display to the user the amount of water being dispensed into a container. Further, in some designs the measurement of the amount of dispensed water can be used to enable a user to select a desired amount of water and have the dispenser automatically shut off when that desired amount has been reached. A need still exists, however, for a manner of accurately measuring the volume of dispensed water.

### SUMMARY

The herein-described embodiments address these and other problems associated with the art by providing a refrigerator and method that utilize a sensor to determine a volume of fluid dispensed to or by one or more components of the refrigerator. For example, to determine a volume of fluid dispensed by a fluid dispenser. The sensor is disposed in fluid communication with the water cartridge (e.g. water filter) to generate a signal representative of a volume of fluid associated with the water cartridge (e.g. entering, exiting, through, interior, exterior), and/or a controller determines the volume of fluid dispensed/filtered/flow/stored using the signal output by the sensor.

In some embodiments, a refrigerator may include a cabinet. In various embodiments, the cabinet may include a case having one or more food storage compartments defined therein and/or one or more doors positioned to access the one or more food storage compartments from an exterior environment. In various embodiments, the refrigerator and/or cabinet may include a refrigerator cartridge head assembly in fluid communication with a water supply. In some embodiments, the refrigerator may include one or more water cartridges. In various embodiments, at least a first water cartridge of the one or more water cartridges may include a housing having a first end and a second end. In some embodiments, the first end may include a first coupler releasably connected to the refrigerator cartridge head assembly between a first configuration wherein the first water cartridge is not in fluid communication with the refrigerator cartridge head assembly and a second configuration wherein the first water cartridge is in fluid communication with the refrigerator cartridge head assembly. In some embodiments, the first end may include a first coupler releasably connected to the refrigerator cartridge head assembly. In various embodiments, the second end may include a first cartridge head assembly. In some embodiments, the first cartridge head assembly may be configured to receive a second coupler of a second water cartridge.

In addition, in some embodiments, the one or more water cartridges may include a filter, a water tank, a sanitizer, and/or an additive. In various embodiments, the refrigerator may include a second water cartridge having a housing having a first end and a second end. In some embodiments, the first end may include a second coupler releasably connected to the first cartridge head assembly between a first configuration wherein the second water cartridge is not in fluid communication with the first cartridge head assembly and a second configuration wherein the second water cartridge is in fluid communication with the first cartridge head assembly. In some embodiments, the first end may include a second coupler releasably connected to the first cartridge head assembly. In various embodiments, the first coupler and the second coupler may be the same. In some embodiments, the first cartridge head assembly may include a first configuration and a second configuration. In various embodiments, when in the first configuration an inlet passage of the first cartridge head assembly may be closed. In some embodiments, when in the second configuration the inlet passage of the first cartridge head assembly may be open and configured to be in fluid communication with a second water cartridge. In various embodiments, two or more of the one or more water cartridges are in fluid communication with each other in series between a water supply line and a water discharge line connected to the refrigerator cartridge head assembly. In some embodiments, the refrigerator may include a dispenser, a container, and/or an ice maker in downstream communication with the refrigerator cartridge head assembly. In various embodiments, two or more of the one or more water cartridges may provide different properties to the water supply.

In some embodiments, a water cartridge for a refrigerator may include a housing having a first end and a second end. In various embodiments, the first end may include a first coupler configured to be releasably connected to a refrigerator cartridge head assembly of a refrigerator between a first configuration configured to not be in fluid communication with a refrigerator cartridge head assembly and a second configuration configured to be in fluid communication with a refrigerator cartridge head assembly. In some embodiments, the second end may include a cartridge head assembly. In various embodiments, the first end may include a first coupler. In some embodiments, the cartridge head assembly may be configured to receive a second coupler of a second water cartridge.

In addition, in some embodiments, the water cartridge may include a second water cartridge having a housing having a first end and a second end. In various embodiments, the first end may include a second coupler releasably connected to the cartridge head assembly between a first configuration wherein the second water cartridge is not in fluid communication with the cartridge head assembly and a second configuration wherein the second water cartridge is in fluid communication with the cartridge head assembly. In some embodiments, the first end may include a second coupler releasably connected to the cartridge head assembly. In various embodiments, the cartridge head assembly may include a first configuration and a second configuration. In some embodiments, when in the first configuration an inlet passage of the cartridge head assembly may be closed. In various embodiments, when in the second configuration the inlet passage of the cartridge head assembly may be open and configured to be in fluid communication with a second water cartridge. In various embodiments, the water cartridge may include a filter, a water tank, a sanitizer, and/or an additive. In some embodiments, the water cartridge may include the water tank, the sanitizer, and/or the additive. In various embodiments, the water cartridge may include a downstream water cartridge that is in fluid communication between an inlet and an outlet of the first coupler. In some embodiments, the water cartridge may be different than the downstream water cartridge.

In some embodiments, a method of assembling two or more water cartridges in fluid communication may include providing a first water cartridge having a housing. In various embodiments, the housing may have a first end and a second end. In various embodiments, the first end may include a first coupler. In some embodiments, the second end may include a first cartridge head assembly. In various embodiments, the method may include providing a second water cartridge having a housing. In some embodiments, the housing may have a first end and a second end. In some embodiments, the first end may include a second coupler. In various embodiments, the second end may include a second cartridge head assembly. In some embodiments, the method may include releasably connecting the second coupler of the second water cartridge in fluid communication with the first cartridge head assembly.

In addition, in some embodiments, the first cartridge head assembly may include a first configuration and a second configuration. In various embodiments, when in the first configuration an outlet of the first cartridge head assembly may be closed. In some embodiments, when in the second configuration the outlet of the first cartridge head assembly may be open and configured to be in fluid communication with the second water cartridge. In various embodiments, the method may include releasably connecting a third water cartridge to the second cartridge head assembly. In some embodiments, the method may include coupling the first water cartridge and the second water cartridge to a refrigerator cartridge head assembly of a refrigerator (e.g. in fluid communication between a water supply line and a water discharge line). In various embodiments, the method may include releasably disconnecting the second coupler of the second water cartridge out of fluid communication with the first cartridge head assembly.

In some embodiments, a water cartridge for a refrigerator may include a housing having a first end and a second end. In some embodiments, the first end may include a first coupler and a first electrical connector. In various embodiments, the first coupler may be configured to be releasably connected to a refrigerator cartridge head assembly of a refrigerator between a first configuration configured to not be in fluid communication with a refrigerator cartridge head assembly and a second configuration configured to be in fluid communication with a refrigerator cartridge head assembly and the first electrical connector configured to be in electrical communication with a refrigerator. In some embodiments, the second end may include a cartridge head assembly and a second electrical connector in electrical communication with the first electrical connector. In various embodiments, the cartridge head assembly may be configured to receive a second coupler and to be in electrical communication with a second water cartridge.

In addition, in some embodiments, the cartridge head assembly may include a first configuration and a second configuration. In various embodiments, when in the first configuration an inlet passage of the cartridge head assembly may be closed and when in the second configuration the inlet passage of the cartridge head assembly may be open and configured to be in fluid communication with a second water cartridge and the second electrical connector may be in electrical communication with a second water cartridge. In some embodiments, the water cartridge may include one or more electronic devices. In various embodiments, the first electrical connector and the second electrical connector may be connected in series. In some embodiments, the first electrical connector and the second electrical connector may be connected in parallel. In various embodiments, the first electrical connector and the second electrical connector may be connected by at least one signal transmitter. In various embodiments, the water cartridge may include one or more electronic devices. In some embodiments, when in the first configuration the first electrical connector may be configured to not be in electrical communication with a refrigerator.

In some embodiments, a water cartridge may include a first end and a second end. In various embodiments, the first end may include one or more first electrical connectors and the second end may include one or more second electrical connectors. In some embodiments, the one or more first electrical connectors may be in electrical communication with the one or more second electrical connectors.

In addition, in some embodiments, the first end may include a first coupler configured to engage a cartridge head assembly of an appliance and/or a cartridge head assembly of another water cartridge. In various embodiments, the second end may include a cartridge head assembly configured to engage another water cartridge. In some embodiments, the water cartridge may include one or more electronic devices. In various embodiments, the one or more first electrical connectors and the one or more second electrical connectors may be connected in series. In some embodiments, the one or more first electrical connectors and the one or more second electrical connectors may be connected in parallel. In various embodiments, the one or more first electrical connectors and the one or more second electrical connectors may be connected by one or more signal transmitters. In some embodiments, the water cartridge may include one or more electronic devices.

In some embodiments, an appliance may have one or more water cartridges. In various embodiments, the appliance may include a first water cartridge having a first end and a second end. In some embodiments, the first end may include one or more first electrical connectors. In various embodiments, the second end may include one or more second electrical connectors. In some embodiments, the one or more first electrical connectors may be in electrical communication with the one or more second electrical connectors. In various embodiments, the appliance may include one or more appliance electrical connectors releasably engaging the one or more first electrical connectors.

In addition, in some embodiments, the first water cartridge may include one or more electronic devices. In various embodiments, the one or more first electrical connectors and the one or more second electrical connectors may be connected in series. In some embodiments, the one or more first electrical connectors and the one or more second electrical connectors may be connected in parallel. In various embodiments, the one or more first electrical connectors and the one or more second electrical connectors may be connected by one or more signal transmitters. In some embodiments, the appliance may include one or more electronic devices. In various embodiments, the appliance may include a cartridge head assembly in fluid communication with a water supply. In some embodiments, the first end of the first water cartridge may include a first coupler releasably connected to the cartridge head assembly between a first configuration wherein the first water cartridge is not in fluid communication with the cartridge head assembly and a second configuration wherein the first water cartridge is in fluid communication with the cartridge head assembly and the one or more first electrical connectors is configured to be in electrical communication with the one or more appliance electrical connectors. In various embodiments, the second end may include a first cartridge head assembly. In some embodiments, the first cartridge head assembly may be configured to engage a second coupler of a second water cartridge and/or the one or more second electrical connectors may be configured to be in electrical communication with the second water cartridge.

In some embodiments, a method of assembling two or more water cartridges in fluid communication may include providing a first water cartridge. In various embodiments, the method may include mechanically engaging the first water cartridge to an appliance. In some embodiments, the method may include fluidly connecting the first water cartridge to the appliance. In various embodiments, the method may include electrically connecting the first water cartridge to the appliance. In some embodiments, the method may include providing a second water cartridge. In various embodiments, the method may include mechanically engaging the second water cartridge to the first water cartridge. In some embodiments, the method may include fluidly connecting the second water cartridge to the first water cartridge. In various embodiments, the method may include electrically connecting the second water cartridge to the first water cartridge. In some embodiments, at least one of the first water cartridge and/or the second water cartridge may include one or more electronic devices.

In some embodiments, an appliance may include a water cartridge removably coupled to the appliance. In various embodiments, the water cartridge may include at least a first portion of one or more sensors. In some embodiments, the one or more sensors generate a signal representative of a volume of water flowing through the water cartridge.

In addition, in some embodiments, the appliance may include a dispensing valve in downstream fluid communication with the water cartridge to control dispensing of water. In various embodiments, the appliance may include a controller coupled to the one or more sensors and the dispensing valve and configured to control the dispensing valve to dispense water and to determine a volume of water dispensed through the dispensing valve based at least in part upon the signal representative of the volume of water flowing through the water cartridge. In some embodiments, the one or more sensors are a flow meter. In various embodiments, the water cartridge is a water filter. In some embodiments, the one or more sensors are only positioned in the water cartridge. In various embodiments, a second portion of the one or more sensors are positioned in a remaining portion of the appliance that does not include the water cartridge. In some embodiments, at least one of the first portion and/or the second portion is electrically connected to the appliance.

In some embodiments, a water cartridge for an appliance may include a housing. In various embodiments, the water cartridge may include a flow sensor. In some embodiments, the flow sensor is integrated in the housing.

In addition, in some embodiments, the flow sensor may include a first portion and a second portion, wherein the housing includes at least one of the first portion and/or the second portion. In various embodiments, the housing may include the first portion of the flow sensor and an appliance includes the second portion of the flow sensor. In some embodiments, the housing may include both the first portion and the second portion of the flow sensor. In various embodiments, the water cartridge is a water filter. In some embodiments, the housing may include one or more electrical connectors configured to electrically communicate with an appliance electrical connector. In some embodiments, the flow sensor may generate a signal representative of a volume of water exiting an outlet of the water cartridge. In various embodiments, the water cartridge may include a coupler configured to be releasably connected to a refrigerator cartridge head assembly of a refrigerator. In some embodiments, the water cartridge may include a cartridge head assembly.

In some embodiments, a method of dispensing water in an appliance may include actuating a dispensing valve in downstream fluid communication with a water cartridge to control dispensing of water from a dispenser. In some embodiments, the method may include actuating a dispensing valve in downstream fluid communication with an outlet of a water cartridge to control dispensing of water from a dispenser. In various embodiments, with a first sensor disposed at least partially in the water cartridge, generating a first signal representative of a volume of water exiting the water cartridge and/or the outlet of the water cartridge. In some embodiments, with a controller, determining a volume of water dispensed through the dispensing valve using the first signal.

In addition, in some embodiments, the method may include controlling the dispensing valve to discontinue dispensing fluid when the determined volume of water dispensed through the dispensing valve reaches a predetermined volume. In various embodiments, the first sensor may be disposed at least partially in the water cartridge and at least partially in a remaining portion of the appliance. In some embodiments, the water cartridge may be a water filter. In various embodiments, the method may include displaying the determined volume of water dispensed through the dispensing valve on a display disposed on at least one of a housing and/or a door of the appliance. In some embodiments, the appliance may be a refrigerator.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a refrigerator consistent with some embodiments of the invention.

FIG. 2 is a sectional view of two water cartridges in fluid communication with a refrigerator cartridge head assembly.

FIG. 3 is an exploded view of FIG. 2 not in fluid communication with each other.

FIG. 4 is a sectional view of three water cartridges in fluid communication with a refrigerator cartridge head assembly.

FIG. 5 is an exploded perspective view of FIG. 4.

FIG. 6 is a perspective view of a refrigerator consistent with some embodiments of the invention, illustrating electrical communication between water cartridges and/or water cartridge(s) and the appliance.

FIG. 7 is a sectional view of two water cartridges in fluid and electrical communication with a refrigerator cartridge head assembly and/or appliance.

FIG. 8 is an exploded view of FIG. 7.

FIG. 9 is a sectional view of three water cartridges in fluid and electrical communication with a refrigerator cartridge head assembly and/or appliance.

FIG. 10 is an exploded perspective view of FIG. 9.

FIG. 11 is another embodiment of the water cartridge, illustrating at least one electronic device in electrical communication in series between electrical connectors and a signal transmitter between electrical connectors.

FIG. 12 is a perspective view of a refrigerator consistent with some embodiments of the invention, illustrating sensing communication between water cartridges and/or water cartridge(s) and the appliance.

FIG. 13 is a sectional view of the water cartridge and a refrigerator cartridge head assembly of an appliance according to the one embodiment of FIG. 12.

FIG. 14 is a sectional view of the water cartridge and a refrigerator cartridge head assembly of an appliance according to one embodiment.

FIG. 15 is a block diagram of an example control system for the refrigerator.

FIG. 16 is a block diagram of an example dispenser suitable for implementing volume determinations consistent with the invention.

FIG. 17 is a flowchart illustrating a sequence of operations for performing a manual dispense using the dispensing system of FIG. 16.

FIG. 18 is a flowchart illustrating a sequence of operations for performing a measured dispense using the dispensing system of FIG. 16.

### DETAILED DESCRIPTION

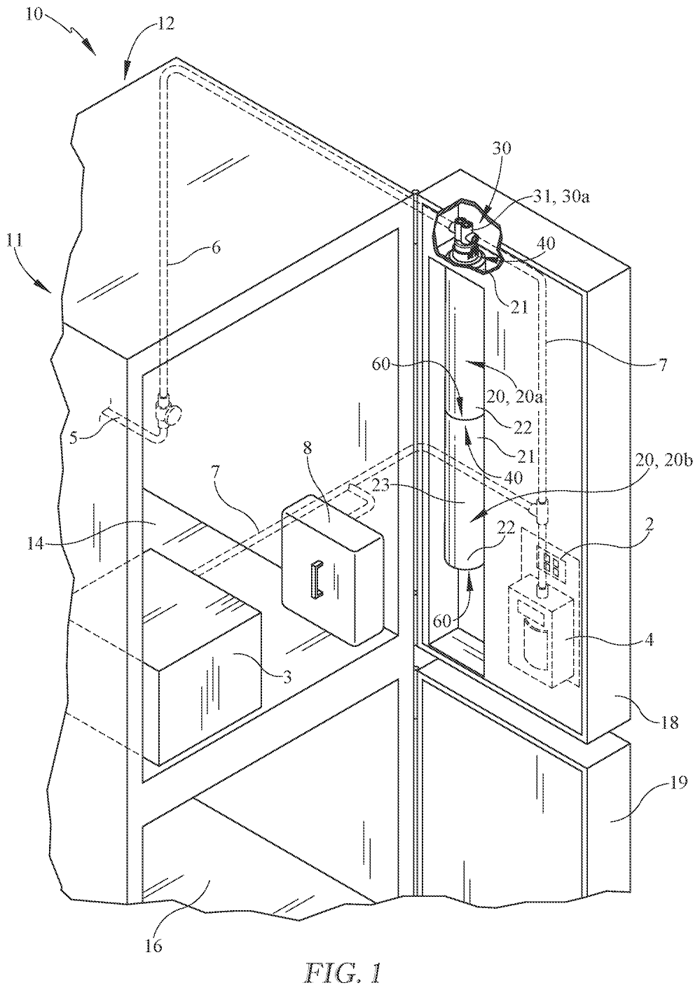

Turning now to the drawings, wherein like numbers denote like parts throughout the several views, FIG. 1 illustrates an example refrigerator 10 in which the various technologies and techniques described herein may be implemented. Refrigerator 10 is a residential-type refrigerator, and as such includes a cabinet 11 including a case 12 (representing the fixed portion or main body of the refrigerator) having/defining one or more food storage compartments (e.g. a fresh food compartment 14 and a freezer compartment 16), as well as one or more fresh food compartment doors 18 and one or more freezer compartment doors 19 disposed adjacent respective openings of food storage compartments 14, 16 and configured to insulate/access the respective food storage compartments 14, 16 from an exterior environment when the doors are closed.

Fresh food compartment 14 is generally maintained at a temperature above freezing for storing fresh food such as produce, drinks, eggs, condiments, lunchmeat, cheese, etc. Various shelves, drawers, and/or sub-compartments may be provided within fresh food compartment 14 for organizing foods, and it will be appreciated that some refrigerator designs may incorporate multiple fresh food compartments and/or zones that are maintained at different temperatures and/or at different humidity levels to optimize environmental conditions for different types of foods. Freezer compartment 16 is generally maintained at a temperature below freezing for longer-term storage of frozen foods, and may also include various shelves, drawers, and/or sub-compartments for organizing foods therein.

Refrigerator 10 as illustrated in FIG. 1 is a type of bottom mount refrigerator. Both the fresh food compartment and the freezer compartment may be considered to be full width as they extend substantially across the full width of the case 12. It will be appreciated, however, that a variety of compartment door designs may be used in other embodiments, including various combinations and numbers of hinged and/or sliding doors for each of the fresh food and freezer compartments (e.g., a pair of French freezer doors, a single sliding freezer door, or one hinged fresh food and/or freezer door). Moreover, while refrigerator 10 is a bottom mount refrigerator with freezer compartment 16 disposed below fresh food compartment 14, the invention is not so limited, and as such, the principles and techniques may be used in connection with other types of refrigerators in other embodiments, e.g., top mount refrigerators, side-by-side refrigerators, etc. Further, other appliances besides refrigerators may be used and still be within the scope of the invention. For example, a stand-alone water systems/appliances (e.g. dispensers, under sink, water fountains) may be used.

In some implementations, the refrigerator 10 may include one or more dispensers 4 for dispensing ice and/or a fluid such as water. The dispenser may be accessible internal or external to the refrigerator. In the illustrated embodiments, dispenser 4, external, is an ice and water dispenser capable of dispensing both ice (cubed and/or crushed) and chilled water, while in other embodiments, dispenser 4 may be a fluid only dispenser for dispensing various fluids such as chilled or cooled water, hot water, coffee, beverages, or other fluids, and may have variable rate and/or fast dispense capabilities, as well as an ability to dispense predetermined or measured quantities of fluids. In some instances, ice and water may be dispensed from the same location, while in other instances separate locations may be provided in the dispenser for dispensing ice and water. The duration of supplying water (e.g. gravity and/or pumped) from dispenser 4 may be manually and/or automatically started and/or ended by the refrigerator 10. The user may manually start and/or end the supplying of water, e.g., based upon a trigger and/or micro switch coupled to a paddle or button on door 18. In other embodiments dispensing (e.g. gravity, pump, and/or pressure) may be automated. For example, water may be dispensed and automatically ended upon a predetermined duration or volume being dispensed, e.g., as determined using the various techniques discussed in greater detail below. Moreover, in various embodiments, a time algorithm may be used to dispense a set amount of water before stopping. Valve 93 may also be electronically activated in some embodiments.

In some implementations, one or more ice makers 3 may be used to receive water and to make ice from the received water. Further, in some embodiments, the water supply may be in fluid communication with removable containers, storage tanks, etc. internally/externally to the refrigerator. To this end, the refrigerator is also provided with a water/fluid supply tube/line 6 to supply water from an external water supply source 5 to the water cartridge(s) 20, refrigerator cartridge head assembly 30, and a water discharge tube/line 7 to supply water customized by the one or more water cartridges to the ice maker 3 and dispenser 4, or the like. The embodiments shown and described can be utilized with many types and styles of refrigerators and/or refrigerator cartridge head assemblies, including, without limitation, described in U.S. Pat. No. 9,115,920, issued Aug. 25, 2015, and CN218511279, published Feb. 21, 2023, the entire contents of which are incorporated herein by reference.

Refrigerator 10 may include a control panel, which in the illustrated embodiment forms at least a portion of the dispenser 4. Control panel 2 may include various input/output controls such as buttons, indicator lights, alphanumeric displays, dot matrix displays, touch-sensitive displays, etc. for interacting with a user. In other embodiments, control panel 2 may be separate from dispenser 4 (e.g. on a door), and in other embodiments, multiple control panels may be provided. Further, in some embodiments audio feedback may be provided to a user via one or more speakers, and in some embodiments, user input may be received via a spoken or gesture-based interface. Additional user controls may also be provided elsewhere on refrigerator 10, e.g., within fresh food and/or freezer compartments 14, 16. In addition, refrigerator 10 may be controllable remotely, e.g., via a smartphone, tablet, personal digital assistant or other networked computing device, e.g., using a web interface or a dedicated app.

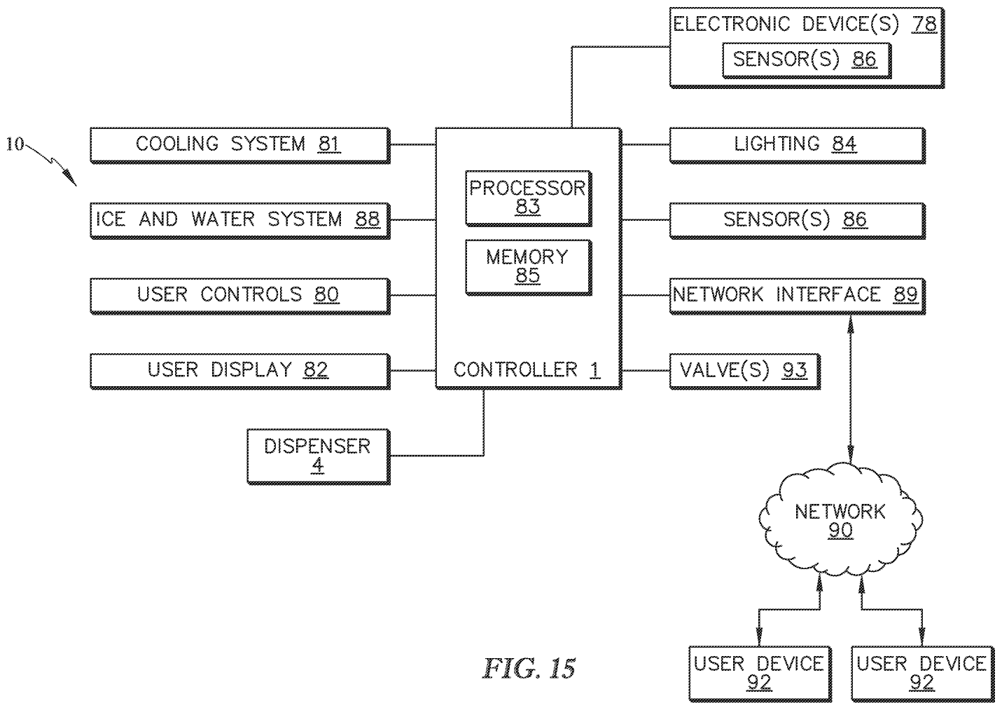

As shown in the one embodiment in FIG. 15, a refrigerator consistent with the invention also generally includes one or more controllers 1 configured to control one or more refrigeration systems as well as manage interaction with a user. A refrigerator 10 may include a controller 1 that receives inputs from a number of components (e.g. water cartridge(s), dispenser, ice and water system, cooling system, user display, valves, electronic devices, sensor 86, flow sensor) and drives a number of components in response thereto. Controller may, for example, include one or more processors and a memory within which may be stored program code for execution by the one or more processors. The memory may be embedded in controller, but may also be considered to include volatile and/or non-volatile memories, cache memories, flash memories, programmable read-only memories, read-only memories, etc., as well as memory storage physically located elsewhere from controller, e.g., in a mass storage device or on a remote computer interfaced with controller.

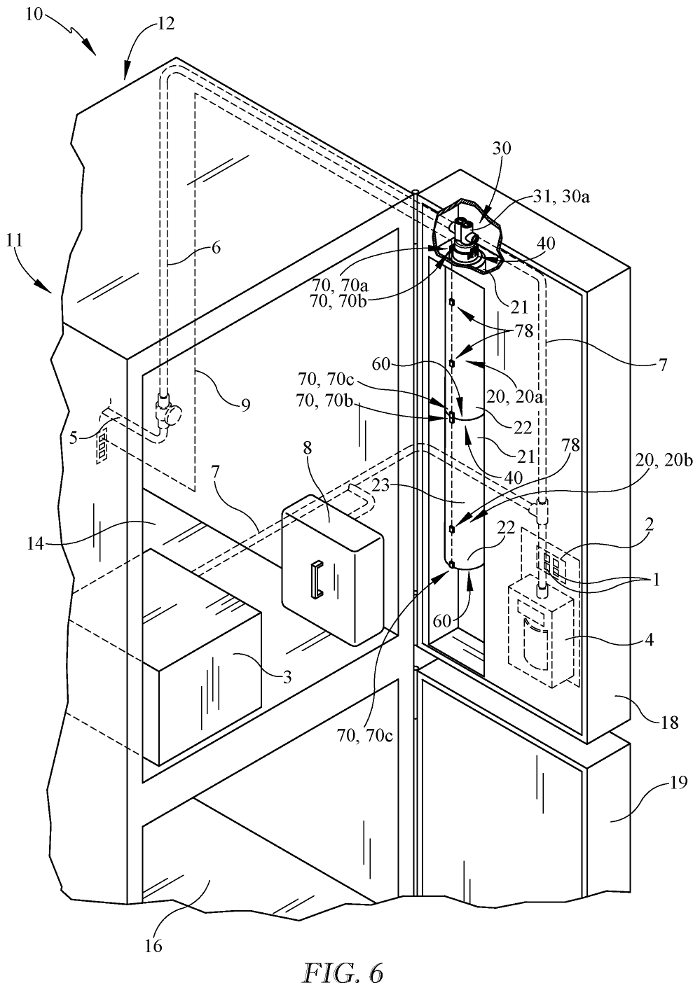

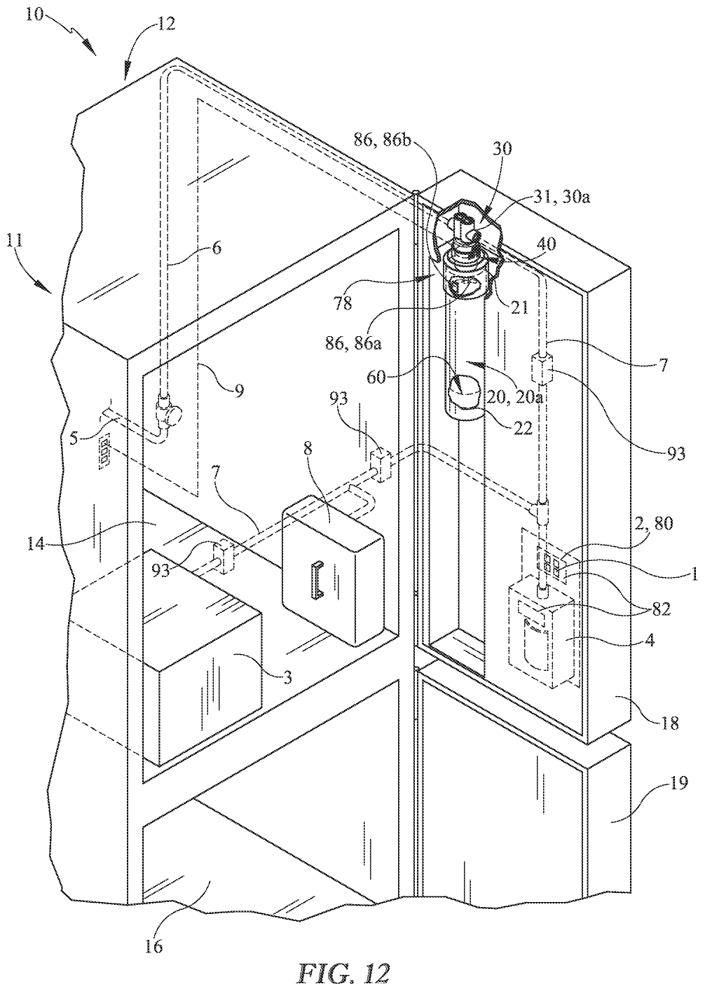

As shown in FIG. 15, a controller 1 may be interfaced with various components, including a cooling or refrigeration system 81, an ice/water system 88 (e.g. water cartridge, dispenser, ice maker, water delivery/handling devices, electronic devices, which may include, among additional ice making and dispensing components, the various components discussed above with respect to dispenser 4, etc.), one or more user controls for receiving user input (e.g., various combinations of switches, knobs, buttons, sliders, touchscreens or touch-sensitive displays, microphones or audio input devices, image capture devices, etc.), and one or more user displays (including various indicators, graphical displays, textual displays, speakers, etc.), as well as various additional components suitable for use in a refrigerator, e.g., interior and/or exterior lighting 84, among others. At least a portion of user controls 80 and user displays 82 may be disposed, for example, on control panel 2 of FIGS. 6 and 12. The one or more control panels disposed in the interior and/or on doors and/or other external surfaces of the refrigerator.

Controller may also be interfaced with various sensors/devices 86 located to sense environmental conditions inside of and/or external to refrigerator 10 and/or water cartridge 20, e.g., one or more temperature sensors, humidity sensors, water cartridge 20, electronic devices 78, flow meter, etc. Such sensors may be internal or external to refrigerator 10 and/or water cartridge 20, and may be coupled wirelessly to controller 1 in some embodiments. Sensors may also include additional types of sensors such as door switches, switches that sense when a portion of an ice dispenser and/or water cartridge(s) has been removed, type(s) of water cartridge being used, characteristics/status of water cartridge/electronic devices, and other status sensors, as will become more apparent below.

In some embodiments, controller 1 may also be coupled to one or more network interfaces 89, e.g., for interfacing with external devices via wired and/or wireless networks such as Ethernet, Wi-Fi, Bluetooth, NFC, cellular and other suitable networks, collectively represented in FIG. 15 at 90. Network 90 may incorporate in some embodiments a home automation network, and various communication protocols may be supported, including various types of home automation communication protocols. In other embodiments, other wireless protocols, e.g., Wi-Fi or Bluetooth, may be used.

In some embodiments, refrigerator 10 may be interfaced with one or more user devices 92 over network, e.g., computers, tablets, smart phones, wearable devices, etc., and through which refrigerator 10 may be controlled and/or refrigerator 10 may provide user feedback.

In some embodiments, the controller may operate under the control of an operating system and may execute or otherwise rely upon various computer software applications, components, programs, objects, modules, data structures, etc. In addition, controller may also incorporate hardware logic to implement some or all of the functionality disclosed herein. Further, in some embodiments, the sequences of operations performed by controller to implement the embodiments disclosed herein may be implemented using program code including one or more instructions that are resident at various times in various memory 85 and storage devices, and that, when read and executed by one or more hardware-based processors 83, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

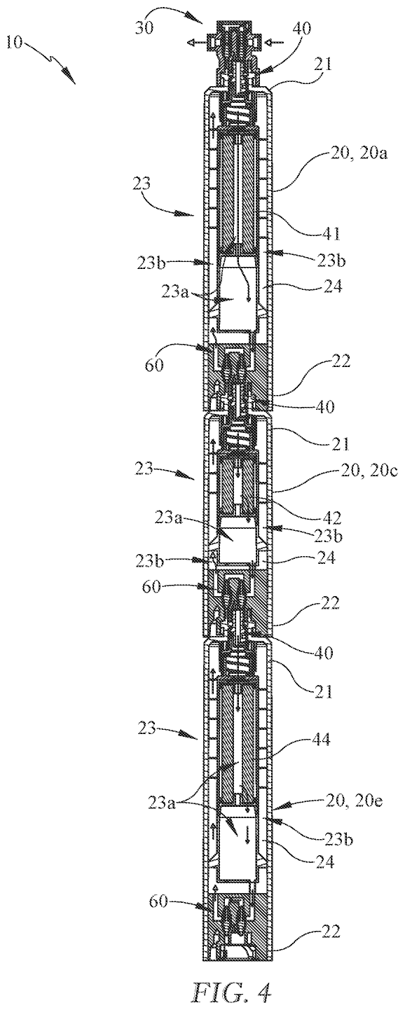

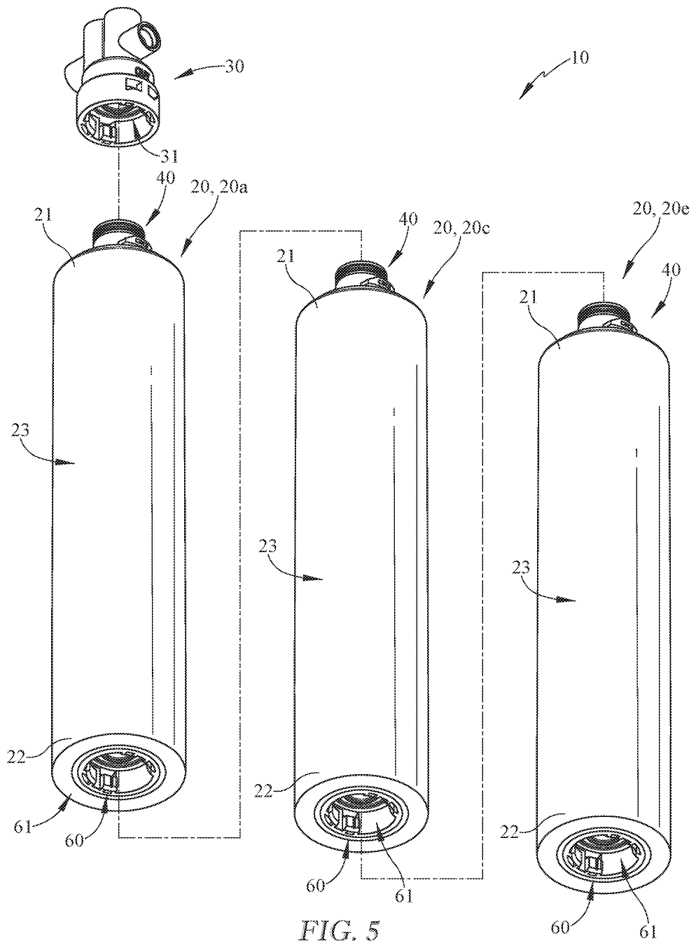

Now turning to FIGS. 1-5, in some embodiments, one or more water cartridges 20 may be used in fluid communication with the water supply (e.g. external water supply source 5, internal) of the refrigerator 10. The one or more water cartridges 20 (e.g. first 20a, second 20b, third 20c, fourth 20d, etc.) may be used alone, in fluid communication with another water cartridge, or in a particular upstream/downstream configuration to effect a change and/or provide/remove different properties to the water supply of the refrigerator. The one or more water cartridges 20 may customize the water therein for/with purity, filtration, flavoring, sanitization, additive, removal, color, temperature, storage capacity, etc. For example, a first water cartridge 20a may include a first filter 41 (e.g. one or more properties). A second water cartridge 20b may include a second filter (e.g. one or more properties). The first filter 41 may be the same or different from the second filter of the second water cartridge 20b. A third water cartridge 20c may include a flavoring 42 (e.g. grape, lemon, lime, etc.). A fourth water cartridge 20d may include a tank/reservoir 43 (e.g. first volume, second volume, third volume, etc.). A fifth water cartridge 20e may include an additive or sanitizer 44 (e.g. chlorine, fluoride, disinfectants, carbonation, sweetener, coloring, medicine, caffeine, alcohol, etc.). Further, the order or sequence and/or quantity of the one or more water cartridges 20 may effect a change to the water supply of the refrigerator or achieve a predetermined or desired consumer outcome. For example, a single water cartridge may be used to change one or more properties of the water. Further, in some implementations as shown in FIGS. 1-3, two water cartridges 20 (e.g. in series) may be used/connected/assembled together. The first water cartridge (e.g. 20a) may be the same or different from the second water cartridge (e.g. 20d). For example, the upstream or first water cartridge 20a may include a first filter 41 and the downstream or second water cartridge 20b may include a tank 43 (e.g. sanitizer 44, second filter 41, or flavoring 42). Alternatively, the second water cartridge may be positioned upstream of the first water cartridge in some embodiments. Further, for example as shown in FIGS. 4 and 5, three or more water cartridges 20 (e.g. in series) may be used or coupled (e.g. fluidly) together. One or more of the three water cartridge may be the same or different from the remaining water cartridges. As shown in the one embodiment in FIGS. 4 and 5, the upstream or first water cartridge 20a may include a filter 41, the middle or second water cartridge 20 (e.g. 20c) may include a flavoring 42, and the last, downstream or third water cartridge 20 (e.g. 20c) may include an additive/sanitizer 44. Alternatively, the upstream or first water cartridge may include a sanitizer, the middle or second water cartridge may be a tank, and the last, downstream or third water cartridge may include a flavoring. These examples of order/sequence/quantity of water cartridge's contents should not be construed as limiting, other configurations and/or properties may be added/removed from or used with the water supply.

The one or more water cartridges 20, or portions thereof, may be a variety of shapes, sizes, quantities, properties, constructions, and/or positions in the appliance (e.g. relative to one or more water handling/delivery devices 50) and still be within the scope of the invention. For example, one water cartridge 20 may be used, two water cartridges 20 may be used, three water cartridges 20 may be used, four water cartridges 20 may be used, or five or more water cartridges 20 may be used. Further, filters of different sizes (e.g. lengths) may be used/coupled together. For example, two half sized filters (e.g. small length) in length may be coupled together to fill/replace a fluid position/length of a longer length cartridge (e.g. large length filter).

In some implementations, the one or more water cartridges 20 may be in fluid communication with one or more water delivery/handling devices 50 (e.g. internal, external) of the refrigerator 10, such as but is not limited to one or more ice makers 3, one or more dispensers 4, one or more containers/tanks 8 (e.g. removable, non-removeable, internal, external), filter, etc. Although the one or more water cartridges 20 are shown as positioned within the door 18, it should be understood that the one or more water cartridges may be in a variety of positions with the refrigerator 10. For example, the one or more water cartridges 20 may be positioned in the casing/housing 12. Further, the one or more water cartridges 20 and/or one or more refrigerator cartridge head assemblies 30 may be positioned upstream from one or more handling/delivery devices 50 and/or downstream from one or more handling/delivery devices 50. Although the one or more water cartridges are shown vertically orientated or in communication with each other, other orientations are still within the scope of the invention. For example, the one or more water cartridges may be horizontally orientated in some embodiments.

In some implementations, the refrigerator 10 and/or water system, or portions thereof, may include one or more cartridge head assemblies (e.g. refrigerator). The refrigerator cartridge head assembly 30, if used, and/or water cartridge(s) 20 may be in fluid communication with at least one water supply line 6 (e.g. upstream) and/or at least one water discharge line 7 (e.g. downstream). The refrigerator cartridge head assembly 30 and/or water cartridge(s) 20 may be upstream of the one or more water handling/delivery devices 50 (e.g. ice maker, dispenser, storage tanks, filters, containers, etc.). Alternatively, or in combination with, the refrigerator cartridge head assembly 30 and/or water cartridge(s) 20 may be downstream of one or more water handling/delivery devices. The refrigerator cartridge head assembly 30, or portions thereof, may releasably couple (e.g. fluid communication) with one or more water cartridges 20. The refrigerator cartridge head assembly may be a variety of shapes, sizes, quantities, constructions, and orientations/positions within the refrigerator and still be within the scope of the invention.

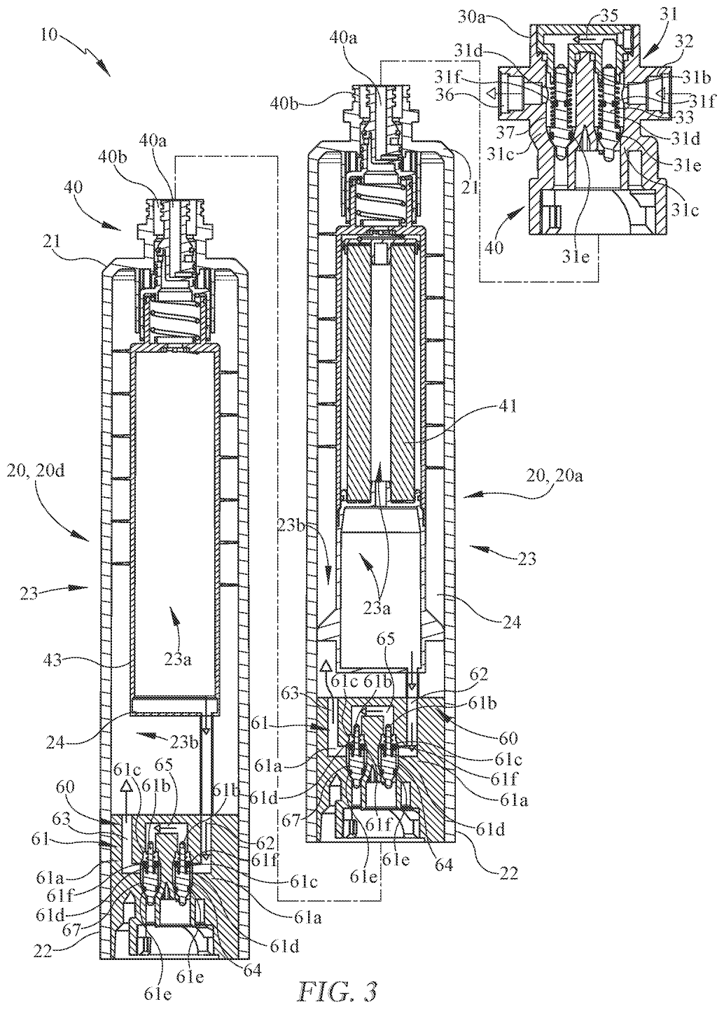

In some implementations, a water cartridge and/or refrigerator, or portions thereof, may include/define/actuate one or more valves 31, or portions thereof, that may fluidly connect (e.g. open, close) the water cartridge with the refrigerator. In the one embodiment shown in the figures, the refrigerator cartridge head assembly 30 may be or include one or more valves 31 that may be in a first configuration or normally open (e.g. bypass passage open) in fluid communication between the water supply line 6 and the water discharge line 7 and a second configuration (e.g. bypass passage closed) in fluid communication with the one or more water cartridges 20. The first configuration may occur when the one or more water cartridges 20 is disconnected from the refrigerator cartridge head assembly 30 (see FIGS. 3 and 5). The second configuration may occur when the one or more water cartridges 20 (e.g. coupler) is coupled to the refrigerator cartridge head assembly 30 (see FIGS. 1, 2, and 4. Further in the second configuration, the water is in fluid communication from the water supply line 6 through the refrigerator cartridge head assembly 30, the one or more water cartridges 20, and then through the refrigerator cartridge head assembly 30 to the water discharge line 7. When in the second configuration or coupled to the refrigerator cartridge head assembly 30, the one or more water cartridges 20 are in fluid communication with each other (e.g. in series) between the water supply line and the water discharge line. Although not shown, the cartridges may be in parallel communication in some embodiments.

In some implementations as shown in FIGS. 1, 2, and 4, refrigerator cartridge head assembly 30 may be releasably coupled to the one or more water cartridges 20 in the second configuration. A body 30a of the refrigerator cartridge head assembly 30 may be provided with a first inlet 32 and a first inlet passage 33, through which water from the water supply source 5 and/or water supply line 6 is introduced. The body 30a is also provided with a first outlet 36 and a first outlet passage 37, through which water treated or circulated through the one or more water cartridges 20 is discharged to the water handling/delivery devices 50 and/or water discharge line 7. A bypass passage 35, which communicates the first inlet passage 33 and first outlet passage 37 when the one or more water cartridges 20 are disconnected therefrom or when in a first configuration, is also provided at the body 30a.

In some implementations when the one or more water cartridges 20 are coupled with the refrigerator cartridge head assembly 30 or body 30a, the water cartridge 20 (e.g. first) or body 23/coupler 40 (e.g. first) is received in or coupled to the body 30a or refrigerator cartridge head assembly 30. The coupler 40, if used, may include one or more passages. The coupler or body 40 (e.g. first) is formed with a first communicating passage 40a to communicate the first inlet passage 33 and the water cartridge 20 (e.g. first, interior, one or more portions/chambers) and downstream water cartridges 20 (e.g. second, third, etc., interior, one or more portions/chambers), if any, and a second communicating passage 40b to communicate the first outlet passage 37 and the water cartridge (e.g. first, interior) and downstream water cartridges(e.g. second, third, etc.), if any.

In some implementations, the refrigerator cartridge head assembly 30, valves 31, and/or body 30a may include one or more valve units 31a are provided at each of the communicating passages 33 and 37. The valve units 31a function to open or close the first inlet passage 33 and first communicating passage 40a, and the first outlet passage 37 and second communicating passage 40b, respectively.

In some implementations, each valve unit 31a includes a valve stem 31b, a support member 31c to support the valve stem 31b, a first elastic member 31d to elastically support the valve stem 31b between the valve stem 31b and the support member 31c, and a second sealing member 31e and a third sealing member 31f arranged around an outer peripheral surface of the valve stem 31b. The first elastic member 31d elastically supports the valve stem 31b when the water cartridge 20 is mounted to or separated from the refrigerator cartridge head assembly 30. Third sealing members 31f seal off or closes the bypass passage 35 (e.g. second configuration, unsealed second sealing member 31e) to allow water to flow from the first inlet passage 33 into the first communication passage 40a, now open, or coupler/water cartridge and into the interior 24 (e.g. inner portion, outer portion) or body 23 of the first water cartridge and into the second communication passage 40b, now open, or coupler 40 before returning through the first outlet passage 37. The third sealing members 31f unseal or opens the bypass passage 35 (e.g. first configuration) to allow water to flow through the bypass while closing the first inlet/outlet passages 33, 37 via the second sealing members 31e.

In some implementations, the coupler 40 of the water cartridge 20 is fitted in the body 30a of the refrigerator cartridge head assembly 30. When the coupler 40 is rotated (e.g. 90°) after being fitted into the socket/body 30a, the coupler 40 (e.g. male) is engaged with the refrigerator cartridge head assembly or body (e.g. female), so that the coupler or water cartridge is coupled to the refrigerator cartridge head assembly.

In some implementations, the water cartridge 20, or portions thereof, (e.g. coupler) actuate the one or more valves 31 or the refrigerator cartridge head assembly 30 when coupling thereto. When in the first configuration, the valve units maintain the bypass passage 35 in the open position, and the first inlet/outlet passages 33, 37 are closed, and when in the second configuration when the water cartridge 20 is engaged to the refrigerator cartridge head assembly 30 the valve(s) (e.g. valve units) allow water to flow from the first inlet passage 33 into the first communication passage 40a, now open, or coupler/water cartridge and into the interior 24 (e.g. inner portion, outer portion) or body 23 of the first water cartridge and into the second communication passage 40b, now open, or coupler 40 before returning through the first outlet passage 37.

In some implementations, two or more water cartridges 20 may be connected, assembled, or in fluid communication with each other. The two or more water cartridges 20 may releasably connect/assemble to the refrigerator cartridge head assembly 30 in fluid communication. The one or more water cartridges 20 may be connected to the water supply (e.g. refrigerator cartridge head assembly) at a single location as shown in the one embodiment. The water may flow into the first water cartridge 20a before entering the downstream water cartridge (e.g. second 20b-20h, etc.). If a third water cartridge 20c is connected in fluid communication with the second water cartridge 20b, the water may flow into the third water cartridge after the second water cartridge. The two or more water cartridges may be connected to each other (e.g. in series, end to end). A first water cartridge may connect to a second water cartridge, a third water cartridge, etc.

In some implementations, a water cartridge (e.g. first, second, third, etc.) may include a body/housing 23 (e.g. elongated, cylindrical) having a first/upstream end 21 and a second/downstream end 22 (e.g. opposing). The water cartridge (e.g. first) may include a coupler 40 (e.g. first) on the first end 21 configured to releasably engage/connect to the refrigerator cartridge head assembly 30 and/or another water cartridge 20 (e.g. cartridge head assembly 60 of another/second water cartridge). The coupler 40 may be a variety of shapes, sizes, quantities, and constructions and still be within the scope of the invention to releasably/fluidly couple to the refrigerator cartridge head assembly 30 and/or another water cartridge 20 (e.g. second end, cartridge head assembly 60). The water cartridge 20 (e.g. first) may include a cartridge head assembly 60 (e.g. first) on the second end 22 to releasably engage or configure to receive the coupler 40 (e.g. second) of another/second water cartridge 20. The cartridge head assembly 60 of the water cartridge may be a variety of shapes, sizes, quantities, and constructions and still be within the scope of the invention to releasably couple to another/downstream water cartridge (e.g. first end, coupler).

In some implementations, an upstream water cartridge and/or a downstream water cartridge, or portions thereof, may include/define/actuate one or more valves 61, or portions thereof, that may fluidly connect (e.g. open, close) the upstream water cartridge with the downstream water cartridge. In the one embodiment shown in the figures, the water cartridge 20 and/or cartridge head assembly 60 may include a first configuration and a second configuration wherein one or more valves 61 are operated between open and closed positions. When in the first configuration an inlet passage 64 and outlet passage 67 of the cartridge head assembly is closed and the bypass passage 65 is open. When in the second configuration the outlet passage 67 and/or inlet passage 64 of the cartridge head assembly 60 is open, with the bypass passage 65 closed, and configured to be in fluid communication with a second water cartridge. In the first configuration, one or more valves 61 (e.g. value units) of the cartridge head assembly 60 are normally closed when the downstream water cartridge (e.g. coupler) is not connected to the cartridge head assembly 60 of the upstream water cartridge. In the second configuration when the coupler 40 or another water cartridge 20 is connected (e.g. fluidly) to the cartridge head assembly, the one or more valves 61 (e.g. valve units 61a) and/or passages (e.g. 64, 67) are open to be in fluid communication with the downstream water cartridge (e.g. interior 24, contents, volume, etc.). The valve unit 61a may include a stem 61b, support member 61c, elastic member 61d, sealing member 61f, and/or sealing member(s) 61e in some embodiments.

In some implementations, a second water cartridge 20b (e.g. 20c-20-h, etc.), if used, may have a housing 23 having a first end 21 and a second end 22. The first end 21 of the second water cartridge 20b may include a second coupler 40 releasably connected to the cartridge head assembly 60 (e.g. first) of a first/upstream water cartridge 20a between a first configuration wherein the second water cartridge is not in fluid communication with the first cartridge head assembly 60 and/or first water cartridge 20a (see FIGS. 3 and 5) and a second configuration wherein the second water cartridge 20b is in fluid communication with the first cartridge head assembly 60 and/or first water cartridge 20a (see FIGS. 1, 2, and 4). Coupling or engaging the second water cartridge 20b (e.g. second coupler), with or without additional water cartridges 20, to the first cartridge head assembly 60 actuates the one or more valves 61 (e.g. units, passages, inlet, outlets) from the closed/first configuration to the open/second configuration. In the second configuration, the downstream water cartridge(s) 20b is in fluid communication downstream of the refrigerator cartridge head assembly 30, first water cartridge 20a (e.g. inner portion, outer/downstream portion), first coupler 40/cartridge head assembly 60 of the first water cartridge 20a, inlet passage and/or outlet passage of the first coupler 40, and/or inlet/outlet of the refrigerator cartridge head assembly 30. The interior 24 or function (e.g. properties applied to or removed from the water supply) of the first water cartridge and the second/additional water cartridge(s) may be different or the same in some embodiments. The user may select the type/function/sequence/quantities of the water cartridge(s) for one or more applications, or in some implementations it may be predetermined. Further, the user may replace/change/add/remove one or more water cartridges 20 to change the properties of the water supply/system of the refrigerator in some embodiments.

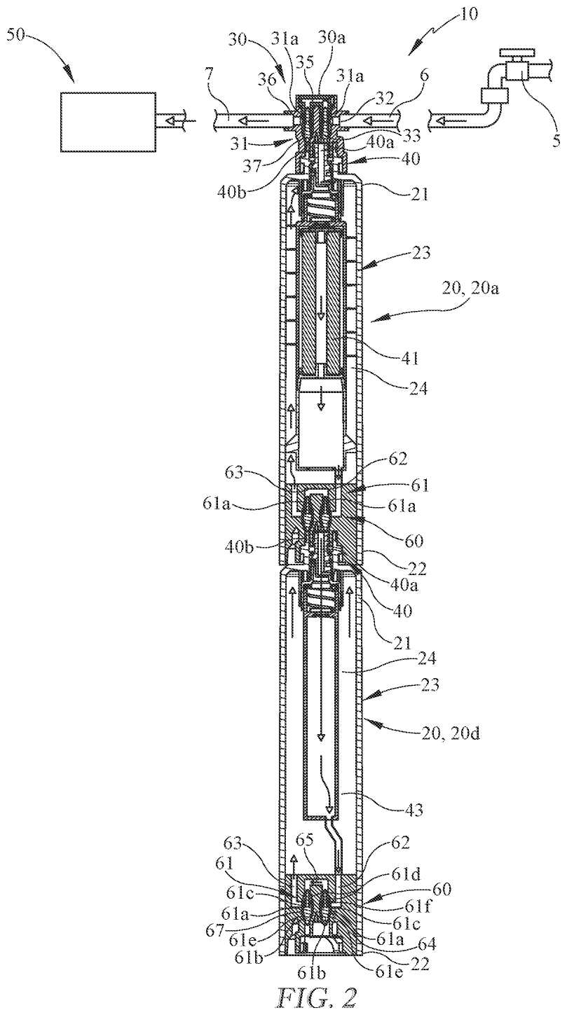

In some implementations, the water cartridge 20, or portions thereof, (e.g. coupler) actuate the one or more valves 61 or the cartridge head assembly 60 when coupling thereto. When in the first configuration, the valve units 61 maintain the bypass passage 65 in the open position, and the inlet/outlet passages 64, 67 are closed. The sealing members 61f are unsealed with the bypass passage 65, while the sealing members 61e engage and seal the inlet/outlet passages 64, 67. The bypass passage is in fluid communication between the inner portion/chamber 23a and the outer portion/chamber 23b when no downstream water cartridge is fluidly connected. As such, the fluid may then flow from the outer portion 23b into the upstream coupler 40, upstream water cartridge (e.g. 60, 23b), if any, and/or refrigerator cartridge head assembly 30. When in the second configuration when the second water cartridge 20b is engaged to the cartridge head assembly 60 the valve(s) (e.g. valve units 61) allow water to flow from the inner portion/chamber 23a of the first water cartridge 20a and the inlet 62/inlet passage 63 into the first communication passage 40a, now open, or downstream coupler/water cartridge 20b and into the inner portion 23a or body 23 of the second water cartridge 20b and into the outer portion 23b of the second water cartridge, if the bypass passage 65 is open (e.g. no more downstream water cartridges are connected). The flow of fluid then continues from the outer portion 23b of the second water cartridge 20b through the second communication passage 40b, now open, or coupler 40 before returning through the outlet 63/outlet passage 67 to the first water cartridge 20a (e.g. outer portion 23b). Alternatively if the bypass passage 65 is closed, for example, by coupling a third water cartridge 20c, the water would flow from the inner portion 23a of the second water cartridge 20b through the now open inlet 62 or inlet passage 63 of the cartridge head assembly 60 of the second water cartridge 20b to the inner portion 23a of the third water cartridge 20c via the coupler 40 of the third water cartridge 20c. For example, as shown in FIG. 2, the cartridge head assembly 60 of the fourth water cartridge 20d is in the first configuration, wherein the bypass passage 65 is open and the inlet/out passages 64, 67 are closed, and the cartridge head assembly 60 of the first water cartridge 20a is in the second configuration, wherein the bypass passage 65 is closed and the inlet/out passages 64, 67 are open. Further for example, as shown in FIG. 4, the cartridge head assembly 60 of the fifth water cartridge 20e is in the first configuration, wherein the bypass passage 65 is open and the inlet/out passages 64, 67 are closed, and the cartridge head assembly 60 of the first water cartridge 20a and third water cartridge 20c is in the second configuration, wherein the bypass passage 65 is closed and the inlet/out passages 64, 67 are open.

In some implementations, if a second water cartridge is used in combination with a first water cartridge the first coupler and the second coupler may be the same. Further, in some embodiments, the first cartridge head assembly and the second cartridge head assembly may be the same. Alternatively, in some implementations, the water cartridges, or portions thereof, may be different. For example, the couplers and/or cartridge head assemblies may be different. Although the refrigerator cartridge head assembly is shown as different than the cartridge head assembly of the water cartridge, they may be the same in some embodiments.

In use, the refrigerator 10 may supply water to the one or more water delivery/handling devices 50 when one or more water cartridges 20 are not connected to or in the first configuration with the refrigerator cartridge head assembly 30. When the user connects one or more water cartridges 20 to at least one refrigerator cartridge head assembly 30, the refrigerator head cartridge head assembly is in fluid communication with the one or more water cartridges in the second configuration. A single water cartridge may be connected to the refrigerator cartridge head assembly 30 in some applications. In other applications, the user or refrigerator may connect a plurality of water cartridges to the refrigerator cartridge heads assembly 30. Fluidly/releasably connecting the coupler 40, first end 21, or water cartridge 20 to the refrigerator cartridge head assembly 30 or cartridge head assembly 60, second end 22, or another water cartridge(s) actuates the one or more valves 31, 61 (e.g. inlet, outlets, passageways(s)) between a closed position and an open position. One or more of water cartridges 20 or couplers 40 may be fluidly/releasably disconnected from the refrigerator cartridge head assembly 30 or cartridge head assembly 60, second end 22, or another water cartridge(s) 20 actuating the one or more valves 31, 61 (e.g. inlet, outlets, passageways(s)) between a closed position and an open position. The water supply may be customized by selecting the contents/function/properties of the one or more water cartridges 20. For example, the water cartridges (e.g. combined end to end, in one or more quantities, in one or more orders) may include a filter, a water/storage tank, a sanitizer, and/or additive or the like in one or more combinations to provide different properties to the water supply and/or one or more water delivery/handling devices. Further, the user may change/remove the order and/or contents of the water cartridges to achieve different properties. Further, the user may replace one or more water cartridges to achieve different properties or to replenish the contents of the replaced water cartridge to achieve the same properties. For example, if a grape flavor water cartridge is depleted the user may replace with another grape flavor water cartridge/refill or replace with an orange flavor water cartridge.

It should be understood that the releasable couplings between water cartridges and/or between the water cartridge and the refrigerator (e.g. refrigerator cartridge head assembly, water supply) may be of a variety of shapes, sizes, quantities, constructions, positions, movement to lock/unlock, and flow passages and still be within the scope of the invention. For example, a variety of valves may be used. Further, the coupling to engage/disengage may be a push and turn engagement in some embodiments. For example, one or more seals may be used.

In some implementations, one or more water cartridges 20 (e.g. first, second, third, etc.) may be electrically connected to the appliance and/or each other. At least one water cartridge 20 may include one or more electronic or electrical connectors/devices 70/78 creating/having electrical communication (e.g. power, signals, transmitter, electronic devices) between the appliance 10 (e.g. refrigerator) and the water cartridge(s) 20 and/or between two or more water cartridges 20. For example, the one or more cartridges 20 may be electrically connected/fluidly connected/mechanically connected to the appliance 10 (e.g. refrigerator) and each subsequent water cartridge 20, if used.

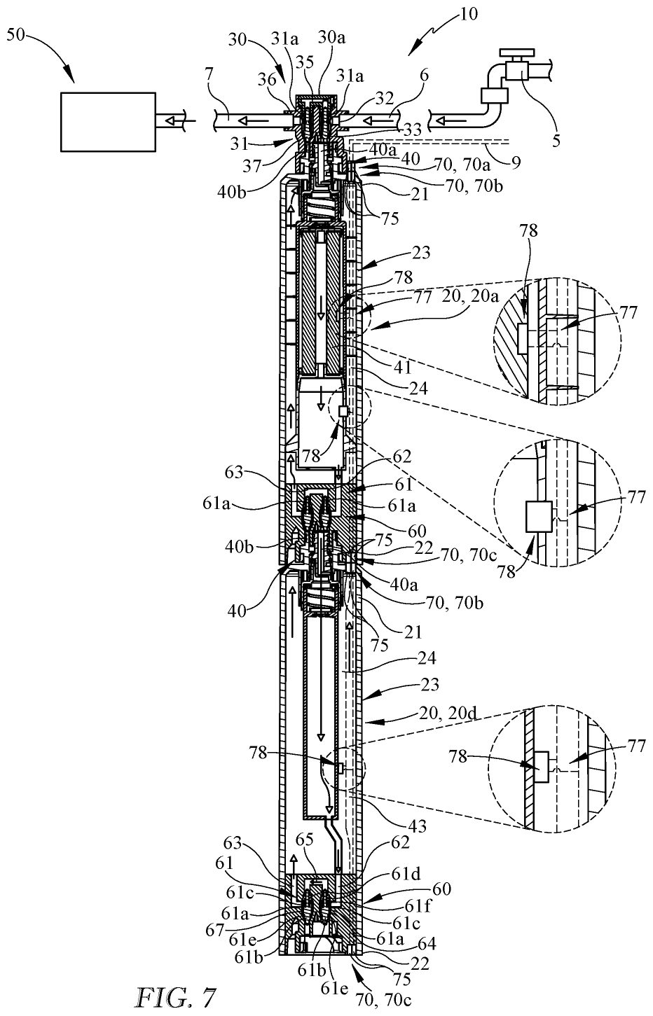

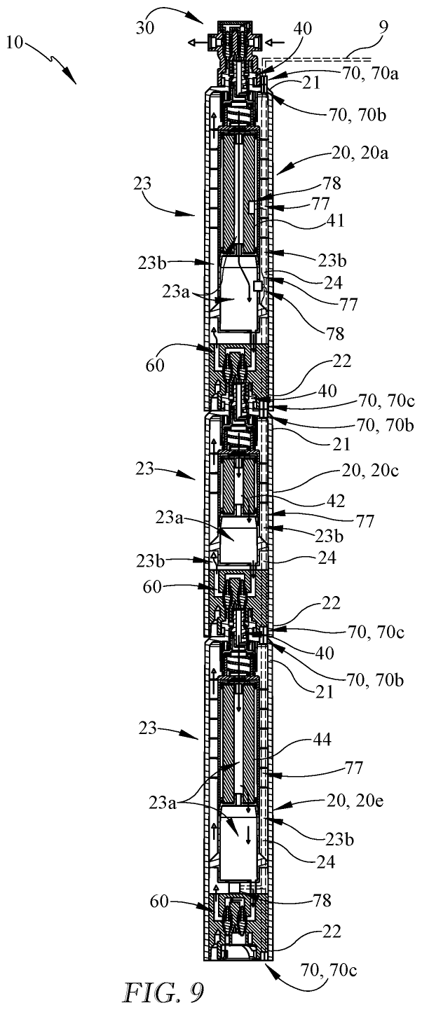

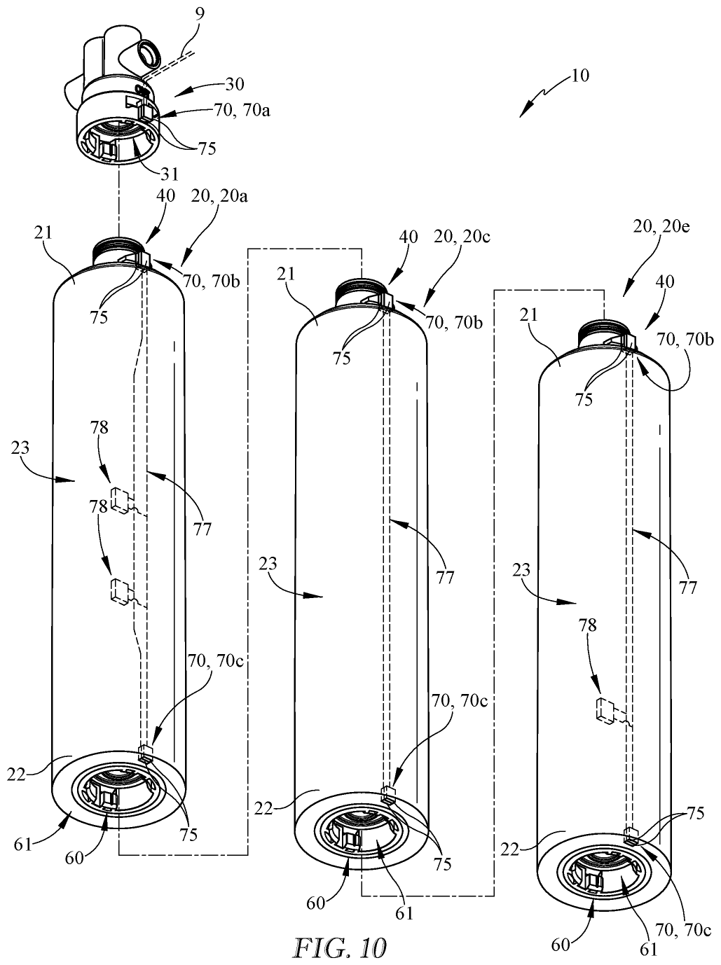

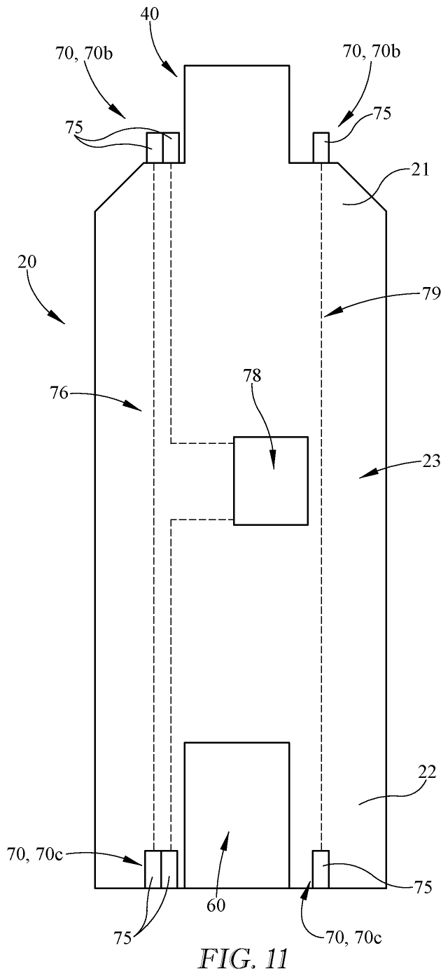

In some implementations, the one or more water cartridges 20 may include one or more electronic devices 78 internal/external to the cartridge 20 (e.g. housing, first end, second end). The characteristics/status of the one or more electronic devices 78 and/or water cartridges 20, or portions thereof, may be in communication with the controller 1. The electronic device(s) 78 may be in a variety of positions within the water cartridge 20. Although the electronic devices 78 are shown as internal to the cartridge 20 in the embodiments shown, it should be understood that the electronic device(s) may be external and/or both internal and external in some embodiments. The electronic devices, if used, in one or more of the one or more water cartridges may be a variety of positions, shapes, sizes, quantities, and constructions and still be within the scope of the invention. The electrical, signal, and/or energized communication of the water cartridge(s) 20 and/or electronic device(s) 78 may be used when in fluid/electrical/mechanical communication and/or not in fluid/electrical/mechanical communication with adjacent water cartridges and/or appliance (e.g. water supply). The one or more electronic devices 78 may be, but is not limited to, flow sensors, UV lighting (e.g. sanitization), data storage, LEDS, lighting (e.g. visibility, status updates on filter and/or flavor packet life), sound (e.g. feedback for install, alerts, alarms), solenoids for measured dispense of water to the consumer, solenoids for measured dispense of additives within the cartridge (e.g. flavorings, minerals, alcohol, etc.), sensor (e.g. pressure, pH, TDS, temperature, filter life, pressure drop, and/or hardness/mineral content), knock-off or counterfeit prevention sensor, energize water for mineral flocculation, etc. In some embodiments as shown in FIGS. 9 and 10, the water cartridge(s) 20, 20c may be energized without a device. For example, the water cartridge 20c as shown in FIG. 9 is in electrical communication between the water cartridges upstream and downstream therefrom. The electrical communication of a water cartridge with (FIGS. 6-11) or without (FIGS. 9 and 10) an electronic device may energize a downstream water cartridge, if connected thereto. In other embodiments, the electrical communication of a water cartridge 20 with (FIG. 11) or without (FIGS. 6-10) an electrical device may include one or more signal transmitters 79 (e.g. where power delivery is not used).

In some implementations, the water cartridge(s) 20, or portions thereof (e.g. electronic device(s)), and/or electrical communication (e.g. power, signal, etc.) may be connected or include a variety of circuits (e.g. series, parallel). The one or more electrical connectors 70 (e.g. first, second, third, etc.), circuits/wires, and/or electronic devices 78 may be connected or be in parallel 77 as shown in the one embodiment in FIG. 6-10. The one or more electrical connectors 70 (e.g. first, second, third, etc.), circuits/wires, and/or electronic devices 78 may be connected or be in in series 76 as shown in the one embodiment in FIG. 11. The one or more electrical connectors 70 (e.g. first, second, third, etc.), or portions thereof, may be in series 76 and/or parallel 77 as shown in the one embodiment in FIGS. 6-11. The one or more electrical connectors 70 (e.g. first, second, third, etc.), circuits/wires, and/or electronic devices may be connected or include one or more signal transmitters 79 (e.g. signal, data) as shown in the one embodiment in FIG. 11. The one or more signal transmitters 79 may be used alone or in combination with another circuit (e.g. series 76 and/or in parallel 77) in the one or more water cartridges. Although not shown, the one or more cartridges 20, or portions thereof, (e.g. electronic device(s)) may be powered separately from each other rather than powered together in the one embodiment shown in the Figures. The electricity in communication with the one or more water cartridges, or portions thereof, may be AC, DC, or combination thereof. The quantity, wires, and/or types of contacts may vary depending on the electricity or electrical communication of the cartridge/appliance, or portions thereof. Although the power is shown as AC, it should be understood that DC may be used in some embodiments.

In some implementations, the water cartridge(s) 20, circuits/wire(s) (e.g. 76, 77, 79), appliance 10, and/or the one or more electrical connectors 70 (e.g. first, second, third, refrigerator, etc.) may include a variety of electrical interfaces or contacts 75 to releasably engage/connect (e.g. electrically) between the water cartridges 20, or portions thereof, and/or water cartridge 20, or portions thereof, and appliance 10, or portions thereof, (e.g. cartridge head assembly, connectors). The one or more electrical connectors 70 (e.g. contacts 75) of the electrical interface may be contacts 75 (e.g. female/male, releasably) engaging and disengaging therebetween. The one or more electrical contacts 75 may releasably engage the corresponding one or more electrical contacts 75. In some embodiments, the one or more refrigerator and/or electrical connectors 70 (e.g. second, refrigerator, one or more contacts) of the refrigerator 10 and/or water cartridge 20 (e.g. second end of the first water cartridge, second water cartridge, third water cartridge, . . . ) may be a target disk or plate and the other electrical connector/engagement (e.g. first, one or more contacts) of the water cartridge (e.g. first end of the first water cartridge, second water cartridge, third water cartridge, . . . ) may be a pogo pin or springed connector (e.g. second). For example, the refrigerator electrical connector 70, 70a may be a target disk/plate in releasable contact with the pogo pin of the first/second/third water cartridge 20a-c (e.g. first end 21, first electrical connector 70). Correspondingly, the second end 22 and/or second electrical connector 70 may be a target disk/plate in releasable contact with a downstream water cartridge 20 or first end 21. In the embodiments shown, the mechanically coupling (e.g. twisting, rotation, first configuration, second configuration) of the water cartridge 20 to the refrigerator cartridge head assembly 30, 60 of the appliance or upstream water cartridge releasably engage/disengage the corresponding electrical connectors/contacts therebetween and/or the fluid communication. However, it should be understood that manual attachment of wire plugs or electrical connectors may be used instead of automatic engagement of the electrical connectors when mechanically/fluidly coupling. Although the upstream or first end electrical connectors and second end electrical connectors are shown to be the same for each water cartridge, it should be understood that the electrical connectors may be different (e.g. shape, size, position, quantity). For example in some implementations, the order of specific water cartridges could be maintained or predetermined or stopped based on the different connectors. The circuits, wires, electronic devices, and/or electrical connectors, or portions thereof, may be waterproof.

In some implementations, the water cartridge(s) and/or body 23, or portions thereof, may include one or more first electrical connectors 70, 70b (e.g. upstream) in electrical communication (e.g. wire(s), electronic device(s), power, signal) with one or more second electrical connectors 70, 70c (e.g. downstream). In the one embodiment shown in FIGS. 6-11, the upstream/first end 21 may include the one or more first electrical connectors 70, 70b and the downstream/second end 22 may include the one or more second electrical connectors 70, 70c. The one or more first electrical connectors 70, 70b may be adjacent the coupler 40 (e.g. first, second, third, etc.) of the water cartridge(s) 20 and may be configured to engage the refrigerator cartridge head assembly 30 (e.g. electrical connectors, cable harness) and/or another/upstream water cartridge (e.g. second end, coupler, electrical connectors). The one or more second electrical connectors 70, 70c may be adjacent the cartridge head assembly 60 (e.g. first, second, third, etc.) of the water cartridge(s) and may be configured to engage another/downstream water cartridge (e.g. first end, coupler, electrical connectors). The contacts 75 or electrical connectors 70 may be on or accessible from the outer periphery of the housing 23.

In some implementations, the water cartridge(s) 20 may include one or more electronic devices 78. The one or more electronic devices 78 of one or more water cartridges 20 may be electrically in communication with each other, appliance 10, water cartridge(s), circuits, and/or one or more connectors 70 (e.g. upstream, downstream) when the water cartridges are mechanically/electrically/fluidly connected. The electronic devices 78, if used, and/or water cartridges 20 may be connected in series or parallel. The water cartridge 20 may include a signal transmitter 79 and/or connectors 70 having a signal to connect electrically between water cartridges and/or between the water cartridge and the appliance, or portions thereof. In some embodiments as shown in FIG. 11, the signal transmitter 79 and one or more electronic devices 78 may be used in the water cartridge 20. In other embodiments, only a signal transmitter may be used. In some embodiments, when no electronic devices are used, the water cartridge 20c (see FIG. 10) may include only power therethrough between water cartridges. In some embodiments not shown, the signal transmitter may be used with only power therethrough, without electronic devices. It should be understood, that water cartridges without electrical communication may still be used with filter cartridges having electrical communication in some implementations. For example, a water cartridge without electrical communication may be added downstream of one or more water cartridges having electrical communication therebetween.

In some implementations, the water cartridge(s) 20 and/or body 23, or portions thereof, may include one or more electrical connectors 70 or contacts 75 (e.g. upstream, downstream, first, second) releasably engaging (e.g. wire(s), electronic device(s), power, signal) with one or more electrical connectors 70 of another water cartridge (e.g. upstream, downstream) and/or an appliance/refrigerator electrical connectors 70. The connectors 70 of the corresponding connectors may electrically engage/disengage automatically with the appliance and/or adjacent water cartridge when fluidly/mechanical engaging/disengaging. For example when in the second configuration, the first coupler 40 is in fluid communication with the appliance cartridge head assembly 30 (e.g. refrigerator) and the one or more first electrical connectors 70, 70b are configured to be in electrical communication with the refrigerator 10 and/or refrigerator electrical connectors 70, 70a. In some embodiments, when the first coupler 40 of the upstream water cartridge 20 is in the first configuration the first coupler and/or the electrical connectors may not be in communication (e.g. electrical, mechanical) with the refrigerator and/or refrigerator electrical connectors. Further for example when in the second configuration, the second coupler 40 of a downstream water cartridge 20 is in fluid communication with the first cartridge head assembly of the upstream water cartridge and the one or more first electrical connectors of the downstream water cartridge is configured to be in electrical communication with the second electrical connectors of the upstream water cartridge. In some embodiments, when the second coupler of the downstream water cartridge is in the first configuration the second coupler and/or the electrical connectors may not be in communication (e.g. electrical, mechanical) with the upstream water cartridge and/or electrical connectors of the upstream electrical connectors. Further, the first cartridge head assembly of the upstream water cartridge would be closed or not in communication (e.g. electrically, fluidly, mechanically) when the downstream water cartridge is not connected.

As shown in the one embodiment in FIGS. 6-8, the water cartridges are in fluid and electrical communication with each other when connected thereto. The water cartridges 20 are in fluid communication with the water supply 5 and electrical communication to the electrical supply 9 (e.g. internal, external, electrical supply source). Each upstream water cartridge 20 is in fluid and electrical communication with the adjacent or successive downstream water cartridge 20 connected thereto, if any. The first water cartridge 20, 20a includes the electrical connectors 70, 70b (e.g. male, female, first) to the appliance 10, or portions thereof, and/or corresponding electrical connectors 70, 70a (e.g. male, female, refrigerator, appliance) as well as one or more electrical connectors 70, 70c (e.g. male, female, second). The one or more electrical connectors 70 are connected to or configured to connect to the corresponding electrical connectors 70b (e.g. male, female, first) of the fourth water cartridge 20d downstream and fluidly connected thereto. The one or more electrical connectors 70 of the fourth water cartridge 20d are not electrically connected to another downstream water cartridge, however the cartridge is configured to releasably engage (e.g. fluidly, electrically, mechanically) another downstream water cartridge. The first water cartridge 20, 20a, as shown in the one embodiment in FIGS. 6-8, includes at least two electronic devices 78, the same or different, connected to the electrical connectors 70 (e.g. 70b, 70c) in parallel. The fourth water cartridge 20, 20d, as shown in the one embodiment in FIGS. 6-8, includes at least one electronic device 78 connected to the electrical connectors 70 (e.g. 70b, 70c) in parallel. The electronic device of the fourth water cartridge may be the same or different than one of the electronic devices of the first water cartridge. Although a plurality of electronic devices may be connected with the same circuit (e.g. parallel, series) within a water cartridge (e.g. 20d), one or more electronic devices 78 may have a first circuit separated from one or more electronic devices 78 having a second circuit within a single water cartridge. Although the devices may be in communication with each other in parallel, it should be understood that the circuit may be in series. The corresponding electrical connectors (e.g. appliance, refrigerator, water cartridge) may be releasably engaged/disengaged when mechanically/fluidly connecting therebetween.

As shown in the one embodiment in FIGS. 9-10, the water cartridges are in fluid and electrical communication with each other when connected thereto. The water cartridges 20 are in electrical communication with each other. The third water cartridge 20, 20c illustrates one or more connectors 70 (e.g. first, second) in parallel, without having one or more electronic devices, to energize the downstream fifth water cartridge 20, 20e. The one embodiment of the first water cartridge 20a includes at least one electronic device 78, but shown as at least two electronic devices 78.

As shown in the one embodiment in FIG. 11, at least one circuit of the water cartridge 20 may be in series. The water cartridge 20 is illustrated having at least one electronic device 78 electrically connected between the electrical connectors 70. Further, at least one signal transmitter 79 is electrically connected between another or separate electrical connectors 70 (e.g. first, second). The one or more signal transmitters may be used with additional circuits having electronic devices as shown, or without electronic devices.

Although the refrigerator/appliance cartridge head assembly is shown having the one or more electrical contacts 75 or connectors 70, the electrical connector 70, 70a of the appliance 10 may be of a variety of positions, quantities, shapes, sizes, and constructions. For example, the appliance cartridge head assembly may be a wire harness. Further, the appliance/refrigerator electrical connector 70, 70a may be separate from the cartridge head assembly in some embodiment.

In use, the first water cartridge 20, 20a, or portions thereof, may be engaged/disengaged to the appliance (e.g. refrigerator, cartridge head assembly, water cartridge) by the user and mechanically, fluidly, and/or electrically be connected/disconnected to or in communication with the appliance/water cartridge, or portions thereof. If desired, one or more additional water cartridges (e.g. first, second, third, etc.) may be engaged/disengaged to the first or upstream water cartridge(s) 20, 20a by the user and mechanically, fluidly, and/or electrically be connected/disconnected to or in communication with the appliance/water cartridge(s), or portions thereof. It should be understood that a single water cartridge and/or a plurality of water cartridges, assembled in communication therebetween, may be engaged/disengaged (e.g. fluid, mechanical, electrical, or combinations thereof) with the appliance/water cartridge(s).

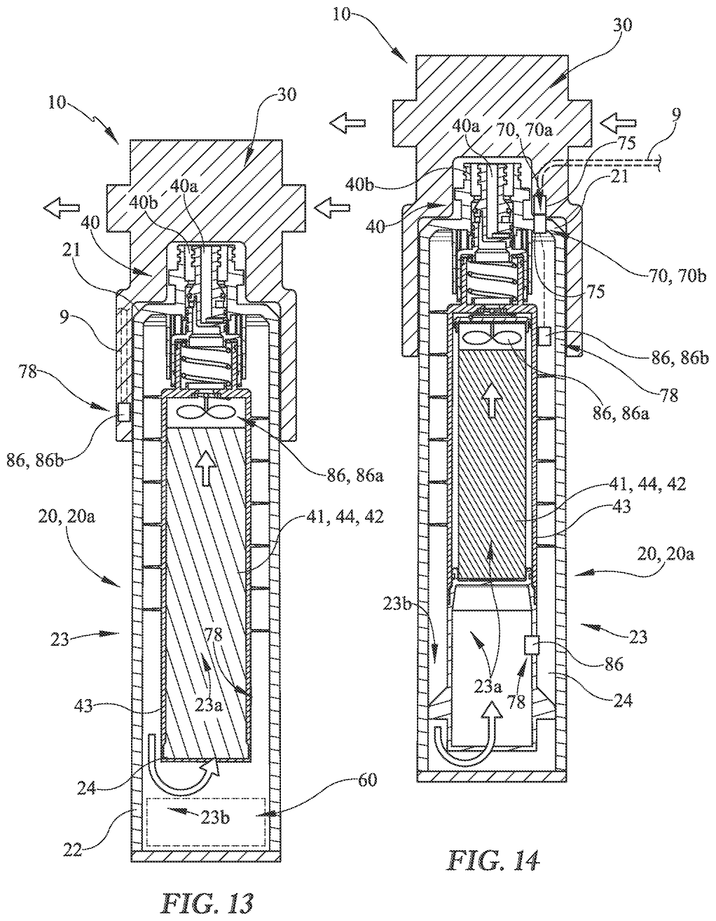

In some implementations as shown in the Figures, the one or more water cartridges 20 (e.g. first, second, etc.) and/or appliance 10, or portions thereof, may include one or more electronic devices 78 (e.g. flow sensor 86), or portions thereof. The sensor 86 (e.g. flow, first portion, first portion 86a and second portion 86b) may be integrated in the water cartridge 20 alone in some embodiments (see FIG. 14), or in combination with another sensor portion 86 (e.g. second portion 86b) of the remaining portion of the refrigerator/appliance 10 (see FIG. 13). The sensor 86 may measure or determine the volume/flow of water relative to the water cartridge 20. The one or more sensors 86 may measure the volume/flow of water entering, exiting, and/or through (e.g. dispensed, usage, measured, flow) the water cartridge to one or more downstream components/uses (e.g. internal the appliance, external the appliance, container, tank, ice maker, dispenser, another water cartridge, etc.)

In some implementations, the one or more sensors 86, appliance 10, and/or water cartridge(s) 20 may include a flow sensor 86, or portions thereof, such as a flow meter to measure or indicate the volume/flow of water (e.g. dispensed). This could be, but is not limited to, generally to display to the user the amount of water being dispensed, to calculate the volume of water flowing into/through/from the filter/cartridge, to display/measure the life span of one or more water cartridges 20 (e.g. water filter, first second), to indicate/display the need for replacement (e.g. water filter), to indicate/display reduced flow, to track usage by the appliance/user, to measure dispense/flow, and/or to automatically shut off valve when desired amount of water is dispensed/allocated.

In some implementations, the flow sensor 86 may include one or more portions. The flow sensor 86 may include at least a first portion 86a and/or a second portion 86b in some embodiments. The housing 23, or portions thereof, of the water cartridge(s) 20 may include at least one of the first portion 86a and/or the second portion 86b. For example as shown in the one embodiment in FIG. 14, the water cartridge 20 may include both the first portion 86a and the second portion 86b. Further, the refrigerator 10, or portions, may not include a third or another portion of the sensor. For example as shown in the one embodiment in FIG. 13, the water cartridge 20 may include the first portion 86a and the remaining portion of the refrigerator 10 (e.g. refrigerator cartridge head assembly 30) may include the second portion 86b. Alternatively for example, the water cartridge 20 may include the second portion and the remaining portion of the refrigerator may include the first portion. Although not shown, the sensor 86 may include a single or first portion 86a and may be located/integrated only in the water cartridge. Although not shown, two portions of the sensor may be split between two or more water cartridges.

In some implementations, the water cartridge(s) 20, or portions thereof, may include one or more portions of the electrical device 78 or flow sensor 86. The housing/body 23 of the water cartridge 20 may include each portion of the one or more flow sensors 86. For example, a water cartridge 20 may include the first/single portion and/or the plurality of portions (e.g. both the first and second portions, each of the three portions, etc.) of the one or more flow sensors 86. Stated alternatively, the one or more flow sensors 86 is only positioned with or integrated in the water cartridge. For example in the one embodiment shown in FIG. 14, the water cartridge 20 (e.g. water filter, body, housing) includes the flow sensor 86 (e.g. each portion, the substantial portions, flow meter, first portion and the second portion). The flow meter or sensor 86 may include a blade/paddle/rotor and a magnetic pick-up/photoelectric cell/gears in some embodiments. The flow meter or sensor 86 may include both the first portion or blade/paddle/rotor 86a and the rotational speed or flow rate may be sensed by the second portion or magnetic pick-up/photoelectric cell/gears 86b positioned with or integrated in the water cartridge.

In some embodiments, one or more portions of the one or more flow sensors 86 (e.g. flow meter) and/or electronic device 78 may not be positioned (e.g. entirely) with the water cartridge(s) 20 (e.g. water filter, housing). One or more portions (e.g. second portion, third portion, etc.) of the one or more sensors may also be positioned outside the water cartridge 20 and/or in a remaining portion of the appliance 10 (e.g. refrigerator, appliance cartridge head assembly, door, housing, etc.), or portions thereof. Alternatively stated, it could be described as portions of the flow sensor 86 are separated and/or removeable from each other and/or may not function if not combined with the other portion. The water cartridge and portion (e.g. first) of the flow sensor may be releasably removable from the remaining portion (e.g. second) of the flow sensor and/or appliance. In some embodiments, at least one first portion 86a of the one or more sensors 86 may be positioned or integrated with the water cartridge 20 and at least one second/other portion 86b of the one or more sensors 86 may be positioned or integrated with the remaining portion of the appliance 10, or portions thereof. For example in the one embodiment shown in FIG. 13, the water cartridge 20 (e.g. water filter, body, housing) may include the first portion 86a of the flow sensor or meter 86 and the remaining portion of the appliance/refrigerator 10 (e.g. appliance cartridge head assembly) may include the second portion 86b of the flow sensor or meter 86. The flow meter or sensor 86 may include a blade/paddle/rotor and a magnetic pick-up/photoelectric cell/gears. The flow meter or sensor 86 may include the first portion or blade/paddle/rotor 86a positioned with or integrated in the water cartridge 20. The flow meter or sensor 86 may include the second portion or magnetic pick-up/photoelectric cell/gears 86b positioned with or integrated in the remaining portion of the appliance, or portions thereof.

Although the sensor or flow meter is shown as a turbine flow meter in the one embodiment, the sensor 86, or portions thereof, may be of a variety of flow meters/sensors, quantities, constructions, positions in the water cartridge, shapes, sizes and still be within the scope of the invention. For example, the flow sensor may be, but is not limited to, differential pressure flow meters, orifice flow meters, venturi flow meters, pitot tube flow meter, positive displacement flow meters, volumetric flow meters, vortex flow meter, magmeter, ultrasonic flow meter, mass flow meter, timer, counter, etc.

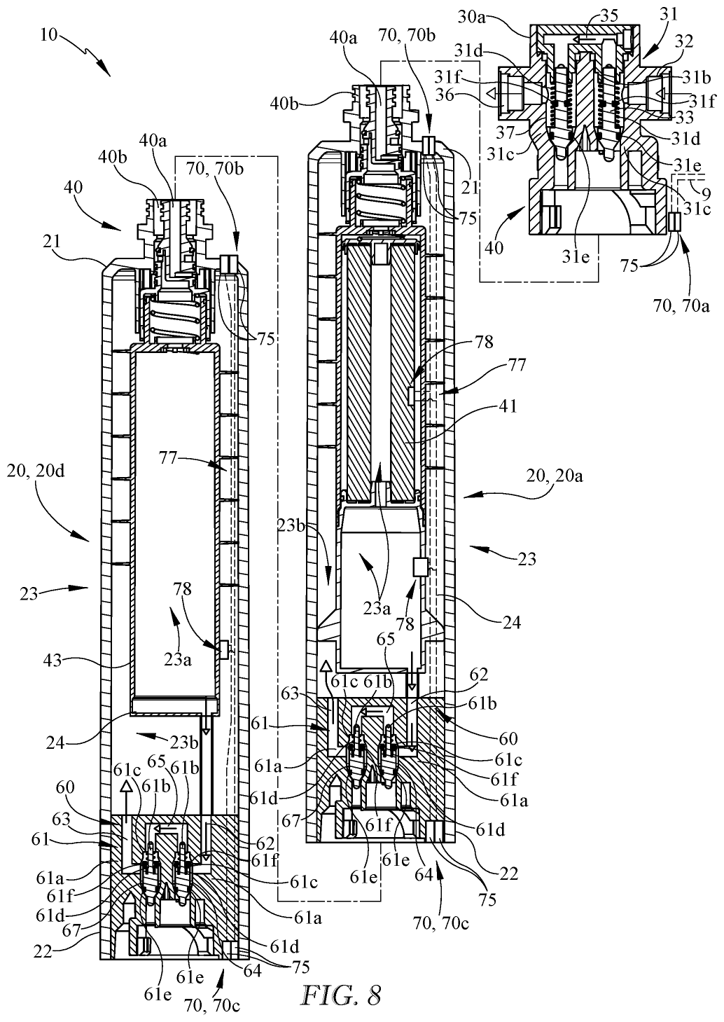

The one or more portions of the sensor 86 (e.g. flow) may be in a variety of positions relative to the water cartridge 20. The one or more portions of the sensor or flow meter 86 may be internal and/or external to the flow of the water cartridge. For example in the one embodiment shown in FIG. 14, the first portion 86a and/or the second portion 86b may be positioned in the fluid flow within the water cartridge 20. For example in the one embodiment shown in FIG. 13, the first portion 86a may be positioned in the fluid flow of the water cartridge 20. The second portion 86b may be positioned external to the flow and/or in the remaining portion of the refrigerator. The sensor 86, or portions thereof, may be positioned before and/or after filtration. If one or more portions of the sensor are not included with the water cartridge, the second portion 86b of the sensor may be in a variety positions with the remaining portion of the appliance. For example, the second portion 86b of the sensor 86 positioned in the refrigerator cartridge head assembly 30, door 18, and/or housing 12. The second portion 86b, if used, in the remaining portion of the appliance 10 may be out of alignment/engagement and/or not in communication with the first portion 86a of the sensor, integrated in the water cartridge 20, when the water cartridge is deployed or removed (e.g. not mechanically/fluidly engaged, from the refrigerator cartridge head assembly). For example, a first or uncoupled configuration as shown in FIGS. 8 and 10. The second portion 86b, if used, in the remaining portion of the appliance 10 may be in alignment/engagement and/or in communication with the first portion 86a of the sensor 86, integrated in the water cartridge, when stowed or releasably engaged (e.g. mechanically/fluidly engaged, with the refrigerator cartridge head assembly). For example, a second or coupled configuration as shown in FIG. 13.

In some implementations, at least one of the portions (e.g. first, second, third, etc.) of the one or more sensors 86 and/or electronic device 78 may be electrically connected to the appliance 10. The water cartridge 20, sensor 86, or housing 23 may not include one or more electrical connectors 70 to electrically communicate with an appliance electrical connector. In the one embodiment shown in FIG. 13, at least one portion (e.g. second portion 86b, third, etc.) of the sensor 86 that is integrated in the remaining portion of the refrigerator 10 (e.g. refrigerator cartridge head assembly 30) may be electrically connected to the appliance. Correspondingly as shown in the one embodiment, the water cartridge 20 or portion of the sensor 86 integrated in the water cartridge 20 may not be electrically connected to the appliance 10. However, in some embodiments, the water cartridge or portion of the sensor 86 integrated in the water cartridge 20 may be electrically connected to the appliance 10. The water cartridge 20 or housing 23 may include one or more electrical connectors 70, 70b, if used, to electrically communicate with an appliance electrical connector 70, 70a, if used. In the one embodiment shown in FIG. 14, at least one portion (e.g. first, second, third, etc.) of the sensor that is integrated in the water cartridge may be electrically connected to the appliance. The water cartridge and/or remaining portion of the refrigerator may include one or more electrical connectors, if used, in communication with the sensor, or portions thereof.

In use, replacing/adding/removing a water cartridge(s) or water filter 20 may change/replace/add the one or more sensors, or portions thereof, and/or upgrade/downgrade/change one or more characteristics (e.g. signals) of the water filter/cartridge and/or flow sensing.

Embodiments consistent with the invention may utilize a sensor(s) 86 to determine a volume of fluid within or dispensed by a refrigerator 10 (e.g. fluid dispenser 4). The sensor 86, e.g., a flow sensor/meter, may be disposed or integrated in at least the water cartridge 20 to generate a signal (e.g. first) representative of a volume flowing through (e.g. entering, exiting, downstream, upstream, relative to, internal, external, interior 24) the water cartridge 20. The flow sensor 86 generates one or more signals representative of a volume of water exiting an outlet or passage 40a of the water cartridge 20 and/or outlet 36 of the refrigerator cartridge head assembly 30. The controller 1 may then determine the volume of fluid dispensed/flow using the signal(s) (e.g. first) output by the sensor(s).

In addition, in various embodiments, water cartridge 20 may include one or more sensors 86, or portions thereof, to monitor characteristics of the water relative to the water cartridge 20 (e.g. dispenser, ice maker, tank, water cartridge, filter). Characteristics of the water may include, but are not limited to, status, water level or volume, duration to fill, flow rate, etc. Sensor 86 may include electronic and/or mechanical devices used to monitor water cartridge 20 and/or water therein and/or relative thereto, such as but not limited to a flow sensor (e.g. flow meter), wired or wireless sensors, etc. In various embodiments, a light or fill gage or other indicators may be used in user interface to highlight the feature and communicate when dispenser 4 is available, measured volume, predetermined volume and/or replace cartridge.

Water filter/cartridge 20 may be disposed in various locations in refrigerator, and in many instances is oriented in a location that enables the water cartridge 20 (e.g. filter) to be replaced by a user periodically. The water cartridge 20 (e.g. filter, one or more portions of the flow sensor) may be removably coupled to the appliance, or portions thereof. The water cartridge 20, with one or more portions of the sensor 86, may include the coupler 40 in some embodiments. Although the water cartridge 20 (e.g. single) may not include the cartridge head assembly 60 and/or connect to another water cartridge as shown in the one embodiment in FIGS. 12-14, the water cartridge 20, with one or more portions of the sensor 86, may include the cartridge head assembly 60, shown in broken lines, in some embodiments. The one or more sensors 86, or portions thereof, may generate at least one signal representative of the volume of water flowing through (e.g. entering, exiting, downstream, upstream, relative to, internal, external, interior 24) the water cartridge, or portions thereof. In some embodiments, the volume of water flowing may be upstream of another water cartridge and/or remaining portion of the refrigerator, or portions thereof. At least a portion of the water cartridge sensor 86 may be in communication (e.g. fluid) with water cartridge to sense a volume of water flowing through (e.g. entering, exiting, downstream, upstream, relative to, internal, external, interior 24) the water cartridge, or portions thereof (e.g. filter), and generate therefrom a signal representative of this volume, which may in turn be communicated to a controller to enable the controller to determine a flow rate or volume through the discharge line 7 and/or water cartridge, and thus a volume of water dispensed. In some embodiments, sensor 86 may be a flow meter/sensor, although other sensors suitable for measuring a volume or flow of water into or towards a container may be used in the alternative. The water cartridge fluid sensor may not be in fluid communication with the fluid in some embodiments.

Refrigerator Fluid Dispenser with Dispensed Volume Calculation

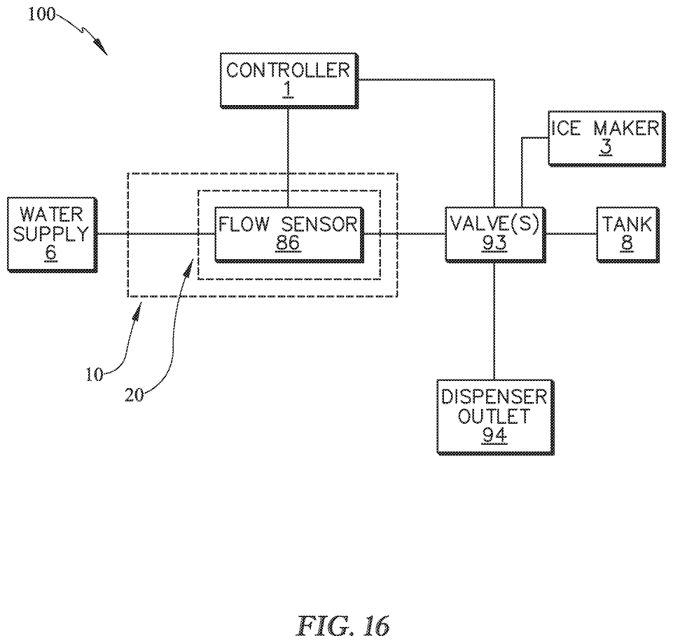

Now turning to FIG. 16, this figure shows more generically a fluid dispensing system 100 suitable for use in a refrigerator such as refrigerator 10 of FIGS. 1, 6, and 12, and incorporating dispensed volume calculation as described herein. In addition, a dispensing valve(s) 93 may be in downstream fluid communication with the water cartridge (e.g. outlet) and/or sensor 86 to control dispensing of fluid from the water cartridge to a dispenser outlet 94, tank 8, ice maker 3, and/or dispenser 4. In some embodiments, the electronic device 78 and/or flow meter/sensor 86 may be positioned or integrated at least partially, or entirely, in the water cartridge 20, while in other embodiments, and as illustrated by broken line, the flow meter/sensor 86 may be integrated with both the water cartridge and the remaining portion of the appliance 10.

The controller 1 may be coupled to the one or more sensors 86 of the water cartridge 20 and/or dispensing valve 93 and configured to control the dispensing valve to dispense water (e.g. measured, predetermined volume, determined volume) The controller 1 may determine the volume of water dispensed through the dispensing valve 93 based on at least part of the signal representative of the volume of water flowing through (e.g. entering, exiting, downstream, upstream, relative to, internal, external, interior 24) the water cartridge 20, or portions thereof, and/or flow sensor 86.

The one or more valves 93 and sensors 96 are additionally coupled to a controller 1 to enable the controller to control dispensing valve(s) 93 to dispense fluid from water cartridge, and to determine a volume of fluid dispensed through dispensing valve 93 using signals generated by sensor(s) 86, or portions thereof.

In the illustrated embodiment, controller 1 may in particular determine a volume of fluid dispensed through dispensing valve 93 using at least the signal output by flow meter 86, using the signal output by flow meter 86 to determine or calculate a volume of fluid leaving the water cartridge and/or during dispensing.

The volume dispensed may be calculated over intervals during which the dispensing valve is open, and may be accumulated over a plurality of polling intervals while the dispensing valve is actuated. The accumulated volume may then be displayed to a user (e.g., via a door-mounted display, via a smartphone display, etc.) and/or used to control when the dispensing valve is deactivated and dispensing is discontinued, e.g., when dispensing a predetermined or controlled volume (e.g. as may be selected by a user via a door-mounted user control or via a smartphone control).

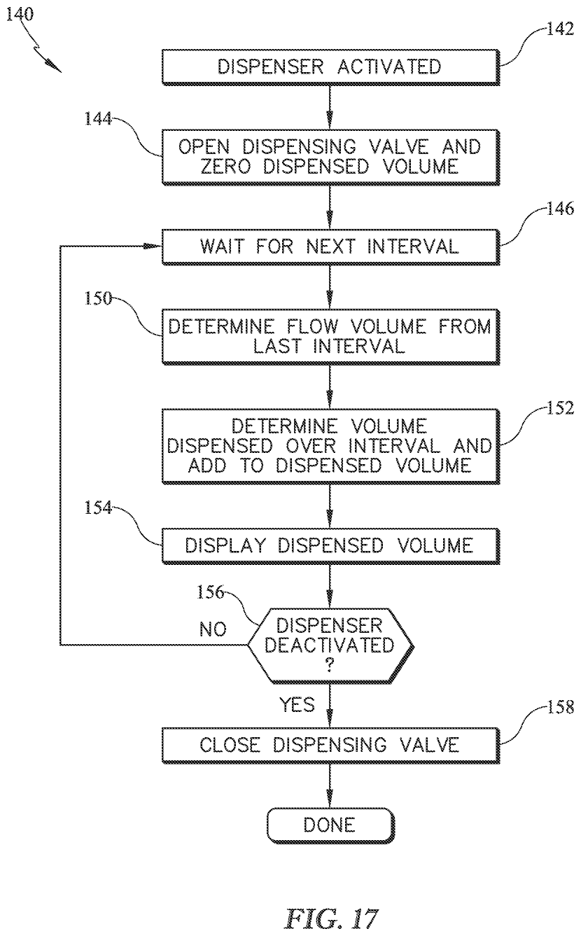

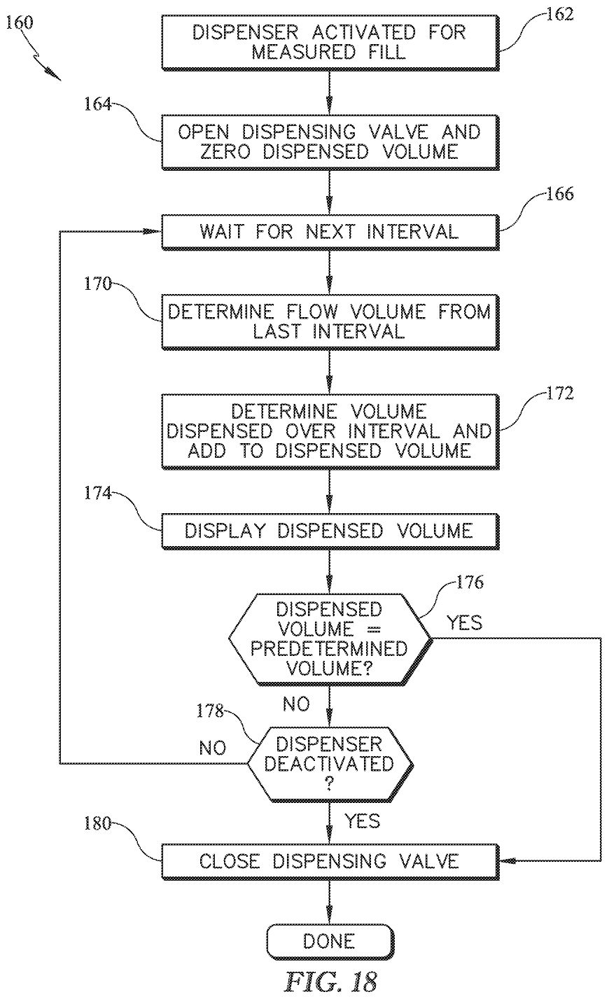

FIGS. 17-18, for example, are flowcharts illustrating several routines that may be executed by a controller, e.g., controller 1 of dispensing system 100, to determine and utilize a determined volume of dispensed fluid.

FIG. 17 illustrates an example implementation of a manual dispense routine 140, which may be used to manually dispense fluid from dispensing system 100, e.g., in response to activation of the dispenser via selection of a button, paddle, or other user control (block 142). First, in block 144, dispensing valve 93 is opened and a dispensed volume variable is set to zero. Block 146 then initiates a loop to continuously dispense fluid and accumulate a total dispensed volume using the dispensed volume variable and over a plurality of polling intervals. For each interval, in block 150 a flow volume since the last interval is determined using the signal output by flow meter 86, e.g., based upon a current flow rate multiplied by the length of the polling interval. Block 152 then determines a volume of fluid dispensed over the interval by the flow volume since the last interval, and then adds the determined volume to the dispensed volume variable, thereby accumulating the determined volumes calculated for each interval. Block 154 next displays the current dispensed volume (e.g., on user interface 82, or on a smartphone display).

Block 156 next determines if the dispenser has been deactivated (e.g., by a user discontinuing depression of a button or a paddle), and if not, returns control to block 146 to wait for the next polling interval. If so, however, block 156 passes control to block 158 to close the dispensing valve, and routine 140 is complete.

FIG. 18 next illustrates an example implementation of a measured dispense routine 160, which may be used to dispense fluid a predetermined amount of fluid from dispensing system 100, e.g., in response to user selection of a predetermined amount in combination with activation of the dispenser via selection of a button, paddle, or other user control (block 162). Blocks 164-174 operate in a similar manner to blocks 144-154 of routine 140. First, in block 164, dispensing valve 93 is opened and a dispensed volume variable is set to zero. Block 166 then initiates a loop to continuously dispense fluid and accumulate a total dispensed volume using the dispensed volume variable and over a plurality of polling intervals. For each interval, in block 170 a flow volume since the last interval is determined using the signal output by flow meter 86, e.g., based upon a current flow rate multiplied by the length of the polling interval. Block 172 then determines a volume of fluid dispensed over the interval by the flow volume since the last interval, and then adds the determined volume to the dispensed volume variable, thereby accumulating the determined volumes calculated for each interval. Block 174 next displays the current dispensed volume (e.g., on user interface 82, or on a smartphone display).

Block 176 next determines if the dispensed volume equals (or exceeds) the predetermined volume for the measured fill, and if not, passes control to block 178 to determine if the dispenser has been prematurely deactivated (e.g., by a user discontinuing depression of a button or a paddle). If not, block 178 returns control to block 166 to wait for the next polling interval. If, however, either the predetermined volume has been reached, or the dispenser has been prematurely deactivated, control passes to block 180 to close the dispensing valve, and routine 160 is complete.

Various modifications may be made to the illustrated embodiments without departing from the spirit and scope of the invention. Other modifications will be apparent to those of ordinary skill having the benefit of the instant disclosure.

It will be appreciated that various additional modifications may be made to the embodiments discussed herein, and that a number of the concepts disclosed herein may be used in combination with one another or may be used separately. Therefore, the invention lies in the claims hereinafter appended.

1. An appliance comprising:
a water cartridge removably coupled to the appliance, wherein the water cartridge includes at least a first portion of one or more sensors; and
wherein the one or more sensors generate a signal representative of a volume of water flowing through the water cartridge.

2. The appliance of claim 1 further comprising a dispensing valve in downstream fluid communication with the water cartridge to control dispensing of water.

3. The appliance of claim 2 further comprising a controller coupled to the one or more sensors and the dispensing valve and configured to control the dispensing valve to dispense water and to determine a volume of water dispensed through the dispensing valve based at least in part upon the signal representative of the volume of water flowing through the water cartridge.

4. The appliance of claim 1 wherein the one or more sensors are a flow meter.

5. The appliance of claim 1 wherein the water cartridge is a water filter.

6. The appliance of claim 1 wherein the one or more sensors are only positioned in the water cartridge.

7. The appliance of claim 1 wherein a second portion of the one or more sensors are positioned in a remaining portion of the appliance that does not include the water cartridge.

8. The appliance of claim 7 wherein at least one of the first portion and/or the second portion is electrically connected to the appliance.

9. A water cartridge for an appliance comprising:
a housing; and
a flow sensor is integrated in the housing.

10. The water cartridge of claim 9 wherein the flow sensor includes a first portion and a second portion, wherein the housing includes at least one of the first portion and/or the second portion.

11. The water cartridge of claim 10 wherein the housing includes the first portion of the flow sensor and an appliance includes the second portion of the flow sensor.

12. The water cartridge of claim 10 wherein the housing includes both the first portion and the second portion of the flow sensor.

13. The water cartridge of claim 9 is a water filter.

14. The water cartridge of claim 9 wherein the housing includes one or more electrical connectors configured to electrically communicate with an appliance electrical connector.

15. The water cartridge of claim 9 wherein the flow sensor generates a signal representative of a volume of water exiting an outlet of the water cartridge.

16. The water cartridge of claim 9 further comprising a coupler configured to be releasably connected to a refrigerator cartridge head assembly of a refrigerator.

17. The water cartridge of claim 16 further comprising a cartridge head assembly.

18. A method of dispensing water in an appliance, comprising:
actuating a dispensing valve in downstream fluid communication with an outlet of a water cartridge to control dispensing of water from a dispenser;
with a first sensor disposed at least partially in the water cartridge, generating a first signal representative of a volume of water exiting the outlet of the water cartridge; and
with a controller, determining a volume of water dispensed through the dispensing valve using the first signal.

19. The method of claim 18 further comprising controlling the dispensing valve to discontinue dispensing fluid when the determined volume of water dispensed through the dispensing valve reaches a predetermined volume.

20. The method of claim 18 wherein the first sensor is disposed at least partially in the water cartridge and at least partially in a remaining portion of the appliance.

21. The method of claim 18 wherein the water cartridge is a water filter.

22. The method of claim 18 further comprising displaying the determined volume of water dispensed through the dispensing valve on a display disposed on at least one of a housing and/or a door of the appliance.

23. The method of claim 18 wherein the appliance is a refrigerator.
